(19) United States
(12) Patent Application Publication
(10) Pub. No.: US 2016/0231658 A1
(43) Pub. Date: Aug. 11, 2016

(54) ELECTROPHOTOGRAPHIC PHOTORECEPTOR AND IMAGE FORMING APPARATUS

(71) Applicant: Konica Minolta, Inc., Tokyo (JP)

(72) Inventors: Hiroshi Nakahara, Tokyo (JP); Toyoko Shibata, Zama-shi (JP); Keiichi Inagaki, Tokyo (JP); Seijiro Takahashi, Tokyo (JP)

(21) Appl. No.: 14/991,358

(22) Filed: Jan. 8, 2016

(30) Foreign Application Priority Data
Feb. 5, 2015 (JP) 2015-020980

(51) Int. Cl. G03G 15/00

(52) U.S. Cl. CPC G03G 5/0614; G03G 5/14708

(57) ABSTRACT

An electrophotographic photoreceptor includes: a conductive support; a photosensitive layer including at least an organic material; and a surface protective layer, wherein the photosensitive layer and the surface protective layer are provided on the conductive support, and the surface protective layer includes a photo-curable crosslinking monomer and a charge transport material including a mixture of a plurality of stereoisomers.

The entire disclosure of Japanese Patent Application No. 2015-020980 filed on Feb. 5, 2015 including description, claims, drawings, and abstract are incorporated herein by reference in its entirety.

### BACKGROUND OF THE INVENTION

1. Field of the Invention

The present invention relates to an electrophotographic photoreceptor and an image forming apparatus. Specifically, the present invention relates to an electrophotographic photoreceptor with high crack resistance and to an image forming apparatus having such an electrophotographic photoreceptor.

2. Description of the Related Art

Organic photoreceptors have advantages such as a wider choice of materials than that of inorganic photoreceptors such as selenium-based photoreceptors and amorphous silicon photoreceptors, high environmental compatibility, and low manufacturing costs. In recent years, therefore, organic photoreceptors have become the main stream of electrophotographic photoreceptors, replacing inorganic photoreceptors.

An image forming method based on Carlson's method includes forming a latent image on an organic photoreceptor by charging, forming a toner image corresponding to the latent image, then transferring the toner image on a transfer medium sheet, and fixing the transferred image to form a final image. In recent years, with the advancement of digital image forming technology, image forming methods using a laser as an exposure light source in the formation of an electrostatic latent image on an organic photoreceptor have been increasingly used.

In such technology, organic photoreceptors have a problem in that their surface can easily wear off due to friction with a contact member such as a cleaning member. To prevent the wear-induced degradation of the surface layer, there is proposed a photoreceptor including a high-wear-resistance polycarbonate resin, specifically, a polycarbonate resin having the central carbon atom in a cyclohexylene group (known as polycarbonate Z (also simply called BPZ)), as a binder in its charge transport layer (see, for example, JP 60-172044A).

However, the organic photoreceptor including this binder does not have sufficiently improved wear resistance.

Alternatively, there is proposed a surface protective layer of a crosslinked cured resin provided on a photoreceptor, in which the crosslinked cured resin is made from a composition including an acrylic polymerizable compound, a charge transporting compound with a polymerizable functional group, and metal oxide particles treated with a surface treatment agent having a polymerizable functional group (see, for example, JP 2010-169725 A). This can improve the wear resistance of photoreceptors.

Although this technique can improve wear resistance, it has the following problem. Since the charge transporting compound is incorporated as part of a resin structure in the surface protective layer, the charge-transporting property of the surface protective layer is low so that an increase in residual potential or image memory (specifically, transfer memory caused by reverse polarity charging during transfer) can easily occur.

To suppress the occurrence of transfer memory, there is proposed a surface protective layer of a crosslinked cured resin provided on a photoreceptor, in which the crosslinked cured resin is made from a composition including an acrylic polymerizable compound, a charge transporting compound with no polymerizable functional group, and metal oxide particles treated with a surface treatment agent having a polymerizable functional group (see, for example, JP 2012-198278 A).

However, when the surface protective layer contains a cured resin and a charge transporting material as mentioned above, there is another problem in that cracks can easily form in the surface protective layer, although transfer memory can be suppressed to some extent.

### SUMMARY OF THE INVENTION

The present invention has been made in view of the above problems and circumstances, and an object of the present invention is to provide an electrophotographic photoreceptor with high crack resistance and to provide an image forming apparatus having such an electrophotographic photoreceptor.

To achieve the object of the present invention, studies have been made on the cause of the problems. As a result, it has been found that an electrophotographic photoreceptor with high crack resistance can be provided using a surface protective layer containing a photo-curable crosslinking monomer and a charge transport material including a mixture of two or more stereoisomers.

Specifically, the object of the present invention is achieved by the following measures.

1. To achieve the abovementioned object, according to an aspect, an electrophotographic photoreceptor reflecting one aspect of the present invention comprises: a conductive support; a photosensitive layer including at least an organic material; and a surface protective layer, wherein the photosensitive layer and the surface protective layer are provided on the conductive support, and the surface protective layer includes a structural unit derived from a photo-curable crosslinking monomer and a charge transport material including a mixture of a plurality of stereoisomers.

2. The electrophotographic photoreceptor according to Item. 1, wherein the most predominant stereoisomer preferably makes up more than 30% by mass to 60% by mass of all the stereoisomers in the charge transport material.

3. The electrophotographic photoreceptor according to Item. 1 or 2, wherein the charge transport material is preferably a compound having a structure represented by formula (1):

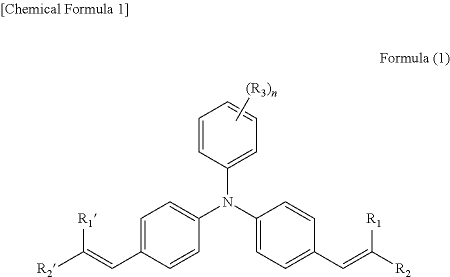

In formula (1), R₁, R₂, R₁′, and R₂′ each independently represent a hydrogen atom or a substituted or unsubstituted aromatic group, R₁≠R₂ and R₁≠R₂′, R₃ represents a hydrogen atom or an alkyl or alkoxy group of 1 to 4 carbon atoms, and n represents an integer of 1 to 5.

4. The electrophotographic photoreceptor according to any one of Items. 1 to 3, wherein the most predominant stereoisomer preferably makes up 45% by mass to 55% by mass of all the stereoisomers in the charge transport material.

5. The electrophotographic photoreceptor according to any one of Items. 1 to 4, wherein the crosslinking monomer preferably has an acryloyl group or a methacryloyl group as a functional group.

6. The electrophotographic photoreceptor according to Item. 1 or 2, wherein the charge transport material is preferably a compound having a triphenylamine structure.

7. The electrophotographic photoreceptor according to Item. 5, wherein the crosslinking monomer preferably has a methacryloyl group.

8. The electrophotographic photoreceptor according to any one of Items. 1 to 7, wherein the crosslinking monomer preferably has a compound with three or more functional groups, and the content of the compound is preferably 50% by mass or more.

9. An image forming apparatus preferably including the electrophotographic photoreceptor according to any one of Items. 1 to 8, a charging unit, an exposure unit, a developing unit, and a transfer unit, wherein the charging unit, the exposure unit, the developing unit, and the transfer unit are preferably provided around the electrophotographic photoreceptor.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic diagram showing a color image forming apparatus according to an embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

The electrophotographic photoreceptor of the present invention includes a conductive support, a photosensitive layer, and a surface protective layer, in which the photosensitive layer includes at least an organic material, and the photosensitive layer and the surface protective layer are provided on the conductive support. The electrophotographic photoreceptor of the present invention has the feature that the surface protective layer includes a photo-curable crosslinking monomer and a charge transport material including a mixture of two or more stereoisomers. This feature is a common or corresponding technical feature in Items. 1 to 6.

In the present invention, the most predominant stereoisomer preferably makes up more than 30% by mass to 60% by mass of all the stereoisomers in the charge transport material. This can increase the potential stability of the electrophotographic photoreceptor.

In the present invention, the charge transport material is preferably a compound having a structure represented by formula (1) below. This can increase the potential stability of the electrophotographic photoreceptor.

In the present invention, the most predominant stereoisomer also preferably makes up 45 to 55% by mass of all the stereoisomers in the charge transport material. This can increase the transfer memory-preventing effect of the electrophotographic photoreceptor.

In the present invention, the crosslinking monomer preferably has an acryloyl group or a methacryloyl group. This allows curing to be performed with a small amount of light or in a short time.

Hereinafter, the present invention, the elements of the present invention, and embodiments and modes for carrying out the present invention will be described in detail. As used herein, the word to means to include the values before and after it as the lower and upper limits.

Hereinafter, the electrophotographic photoreceptor of the present invention and the image forming apparatus of the present invention will be described, respectively.

<<Electrophotographic Photoreceptor>>

The electrophotographic photoreceptor of the present invention includes a conductive support, a photosensitive layer, and a surface protective layer, in which the photosensitive layer includes at least an organic material, the photosensitive layer and the surface protective layer are provided in this order on the conductive support, and the surface protective layer includes a photo-curable crosslinking monomer and a charge transport material including a mixture of two or more stereoisomers. The photosensitive layer includes a charge generating layer and a charge transport layer, in which the charge generating layer is provided on the conductive support, and the charge transport layer is provided on the charge generating layer. An intermediate layer is preferably provided between the conductive support and the charge generating layer.

Hereinafter, each layer constituting the electrophotographic photoreceptor of the present invention, and materials and other conditions for each layer will be described in detail.

<<Surface Protective Layer>>

(1) Photo-Curable Crosslinking Monomer

In the present invention, the photo-curable crosslinking monomer is preferably a monomer capable of being polymerized (cured) by irradiation with active rays such as ultraviolet rays or electron beams to form polystyrene, polyacrylate, or any other resin that can be used as a binder resin for general photoreceptors. Specifically, the photo-curable crosslinking monomer is preferably, for example, a styrene monomer, an acrylic monomer, a methacrylic monomer, a vinyltoluene monomer, a vinyl acetate monomer, an N-vinylpyrrolidone monomer, or the like.

In particular, the photo-curable crosslinking monomer is preferably a radically polymerizable compound having an acryloyl group (CH₂═CHCO—) or a methacryloyl group (CH₂═CCH₃CO—), which is curable with a small amount of light or in a short time.

In the present invention, these radically polymerizable compounds may be used alone or in a mixture. These radically polymerizable compounds may be used in their monomer form or otherwise may be oligomerized before use.

Hereinafter, examples of the radically polymerizable compound will be shown. Hereinafter, the term “Ac group number” (acryloyl group number) or “Mc group number” (methacryloyl group number) refers to the number of acryloyl or methacryloyl groups.

| | | |
|---|---|---|
| Illustrative | Structural | Ac group |
| compound No. | formula | number |

[Chemical Formula 2]

| | | |
|---|---|---|
| Ac-1 | 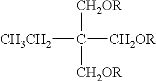 | 3 |
| Ac-2 | 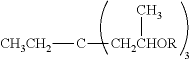 | 3 |
| Ac-3 | 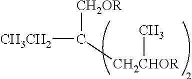 | 3 |
| Ac-4 | 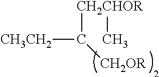 | 4 |
| Ac-5 | 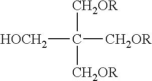 | 3 |
| Ac-6 | 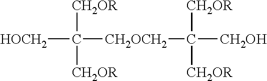 | 3 |

[Chemical Formula 3]

| | | |
|---|---|---|
| Ac-7 | 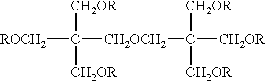 | 6 |
| Ac-8 | 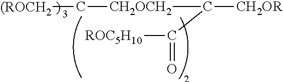 | 6 |
| Ac-9 | 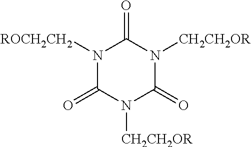 | 3 |
| Ac-10 | 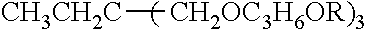 | 3 |
| Ac-11 | 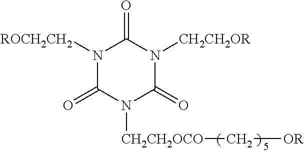 | 3 |

[Chemical Formula 4]

| | | |
|---|---|---|
| Ac-12 | 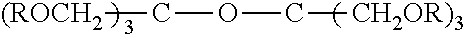 | 6 |
| Ac-13 | 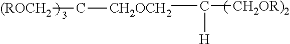 | 5 |
| Ac-14 | 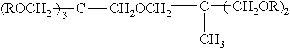 | 5 |
| Ac-15 | 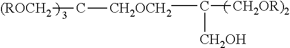 | 5 |
| Ac-16 | 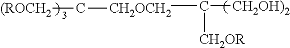 | 4 |
| Ac-17 | 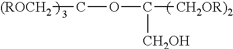 | 5 |

[Chemical Formula 5]

| | | |
|---|---|---|
| Ac -18 | 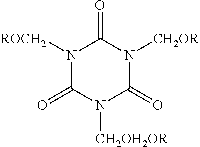 | 3 |
| Ac-19 | 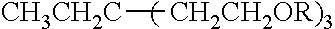 | 3 |
| Ac-20 | 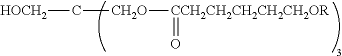 | 3 |
| Ac-21 | 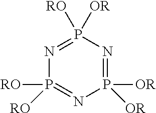 | 6 |
| Ac-22 | 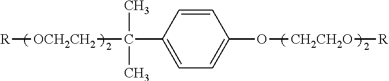 | 2 |
| Ac-23 | 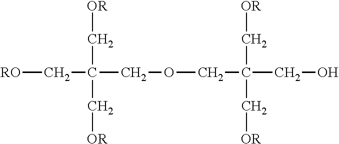 | 5 |

[Chemical Formula 6]

| | | |
|---|---|---|
| Ac-24 | 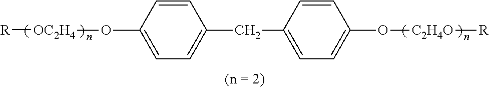 | 2 |
| Ac-25 | 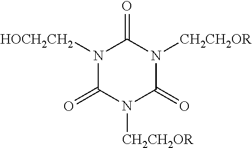 | 2 |
| Ac-26 | 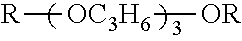 | 2 |
| Ac-27 | 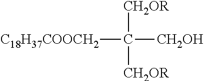 | 2 |
| Ac-28 | 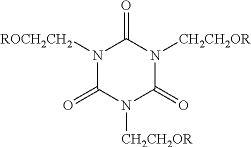 | 3 |
| Ac-29 | 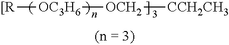 | 3 |
| Ac-30 | 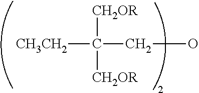 | 4 |
| Ac-31 | 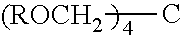 | 4 |

[Chemical Formula 7]

| | | |
|---|---|---|
| Ac-32 | 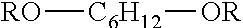 | 2 |
| Ac-33 | 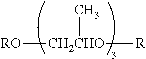 | 2 |
| Ac-34 | 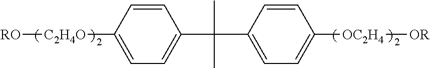 | 2 |
| Ac-35 | 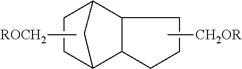 | 2 |
| Ac-36 | 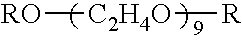 | 2 |
| Ac-37 | 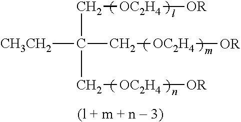 | 3 |
| Ac-38 | 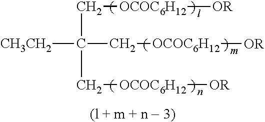 | 3 |

[Chemical Formula 8]

| | | |
|---|---|---|
| Ac-39 | 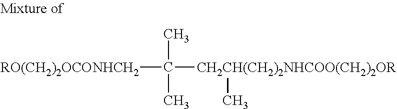 | 2 |
| | 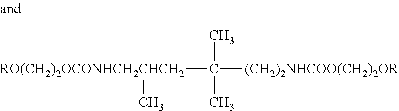 | 2 |
| Ac-40 | (ROCH₂)₃CCH₂OCONH(CH₂)₆NHCOOCH₂C(CH₂OR)₃ | 6 |
| Ac 41 | 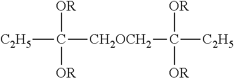 | 4 |

In each formula, R represents the following formula:

| | | |
|---|---|---|
| Illustrative | | |
| com- | Structural | Mc group |
| pound No. | formula | number |

[Chemical Formula 9]

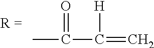

[Chemical Formula 10]

| | | |
|---|---|---|
| Mc-1 | 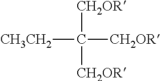 | 3 |
| Mc-2 | 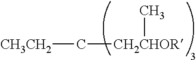 | 3 |
| Mc-3 | 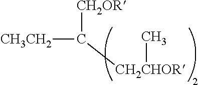 | 3 |
| Mc-4 | 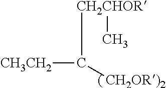 | 3 |
| Mc-5 | 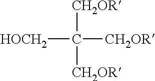 | 3 |
| Mc-6 | 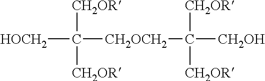 | 4 |

[Chemical Formula 11]

| | | |
|---|---|---|
| Mc-7 | 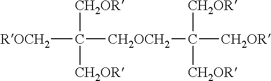 | 6 |
| Mc-8 | 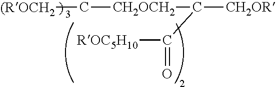 | 6 |
| Mc-9 | 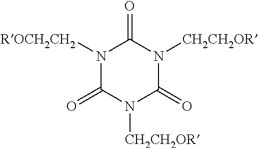 | 3 |
| Mc-10 | 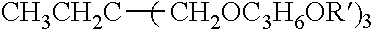 | 3 |
| Mc-11 | 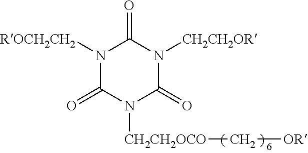 | 3 |

[Chemical Formula 12]

| | | |
|---|---|---|
| Mc-12 | 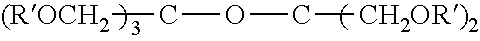 | 6 |
| Mc-13 | 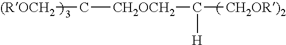 | 5 |
| Mc-14 | 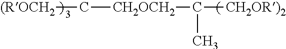 | 5 |
| Mc-15 | 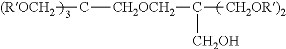 | 5 |
| Mc-16 | 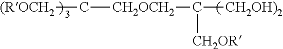 | 4 |
| Mc-17 | 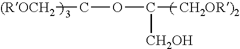 | 5 |

[Chemical Formula 13]

| | | |
|---|---|---|
| Mc-18 | 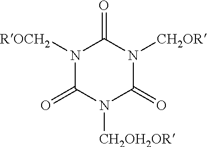 | 3 |
| Mc-19 | 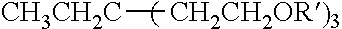 | 3 |
| Mc-20 | 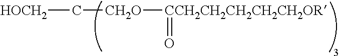 | 3 |
| Mc-21 | 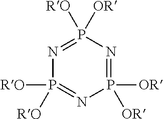 | 6 |
| Mc-22 | 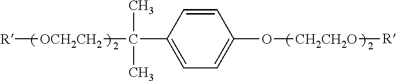 | 2 |
| Mc-23 | 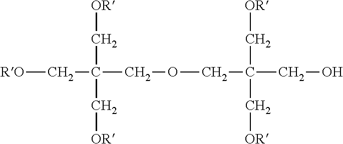 | 6 |

[Chemical Formula 14]

| | | |
|---|---|---|
| Mc-24 | 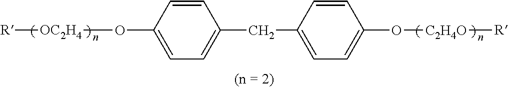 | 2 |
| Mc-25 | 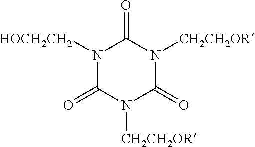 | 2 |
| Mc-26 | 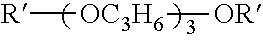 | 2 |
| Mc-27 | 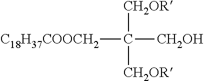 | 2 |
| Mc-28 | 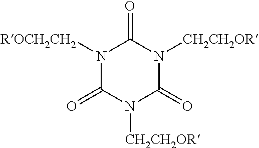 | 3 |
| Mc-29 | 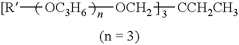 | 3 |
| Mc-30 | 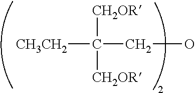 | 4 |
| Mc-31 | 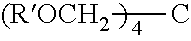 | 4 |

[Chemical Formula 15]

| | | |
|---|---|---|
| Mc-32 | 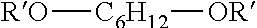 | 2 |
| Mc-33 | 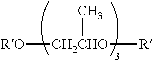 | 2 |
| Mc-34 | 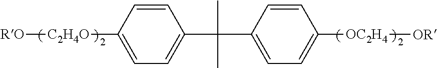 | 2 |
| Mc-35 | 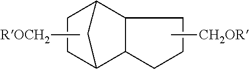 | 2 |
| Mc-36 | 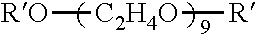 | 2 |
| Mc-37 | 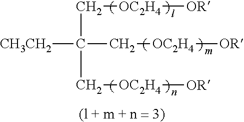 | 3 |
| Mc-38 | 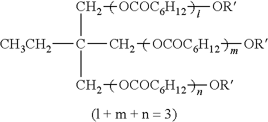 | 3 |

[Chemical Formula 16]

| | | |
|---|---|---|
| Mc-39 | 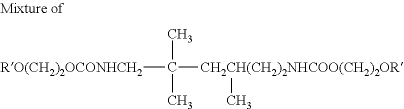 | 3 |
| | 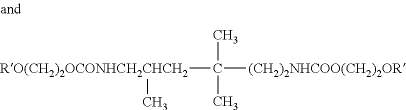 | 2 |
| Mc-40 | (R′OCH₂)₃CCH₂OCONH(CH₂)₆NHCOOCH₂C(CH₂OR′)₃ | 6 |
| Mc-41 | 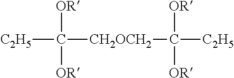 | 4 |

In each formula, R′ represents the following formula:

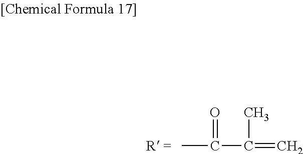

The radically polymerizable compound to be used preferably has three or more functional groups (in other words, reactive groups). Two or more radically polymerizable compounds may also be used in combination. Also in this case, the content of a radically polymerizable compound with three or more functional groups is preferably 50% by mass or more. The curable reactive group equivalent, namely, the ratio of the molecular weight of the curable functional group to the number of the functional groups (the molecular weight of the curable functional group/the number of the functional groups) is preferably 1,000 or less, more preferably 500 or less. This can increase the crosslink density and the wear resistance.

The reaction of the radially polymerizable compound used in the present invention may be performed using a method of subjecting the compound to an electron beam cleavage reaction or a method of adding a radical polymerization initiator to allow the compound to react upon exposure to light or heat. The polymerization initiator may be any one of a photopolymerization initiator and a thermal polymerization initiator. Both photo- and thermal polymerization initiators may also be used in combination.

The radical polymerization initiator for the photo-curable compounds is preferably a photopolymerization initiator, in particular preferably an alkylphenone compound or a phosphine oxide compound. Specifically, the polymerization initiator is preferably a compound having an α-hydroxyacetophenone structure or an acylphosphine oxide structure. A compound capable of initiating cationic polymerization may also be used, examples of which include an ionic polymerization initiator such as a B(C₆F₅)₄⁻, PF₆⁻, AsF₆⁻, SbF₆⁻, or CF₃SO₃⁻ salt of an aromatic onium compound such as diazonium, ammonium, iodonium, sulfonium, or phosphonium, and a nonionic polymerization initiator such as a sulfonated compound capable of generating sulfonic acid, a halide capable of generating hydrogen halide, or an iron-allene complex. Particularly preferred is a nonionic polymerization initiator, specifically, a sulfonated compound capable of generating sulfonic acid or a halide capable of generating hydrogen halide.

Examples of the photopolymerization initiator will be shown below, which can be preferably used.

Examples of α-Aminoacetophenone Compound

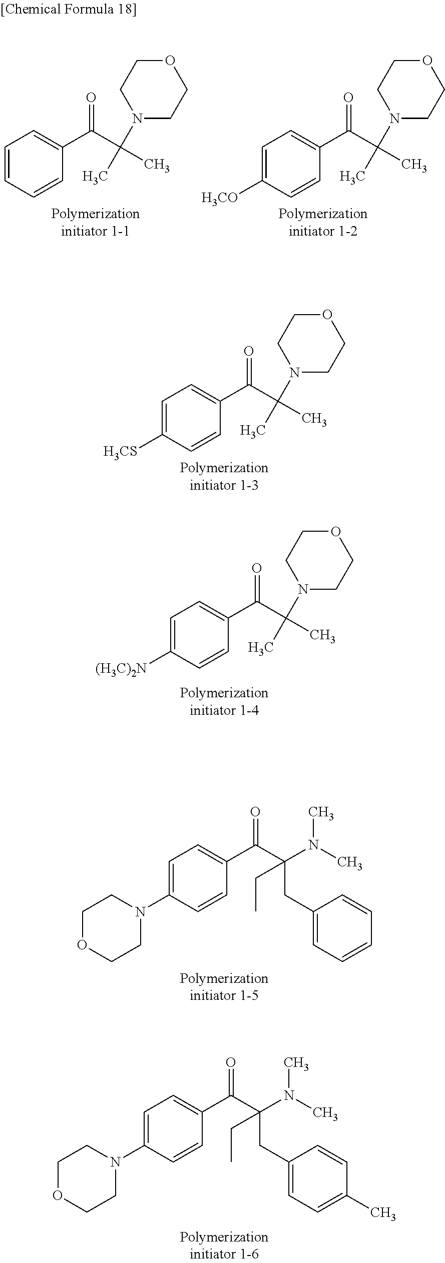

Examples of α-Hydroxyacetophenone Compound

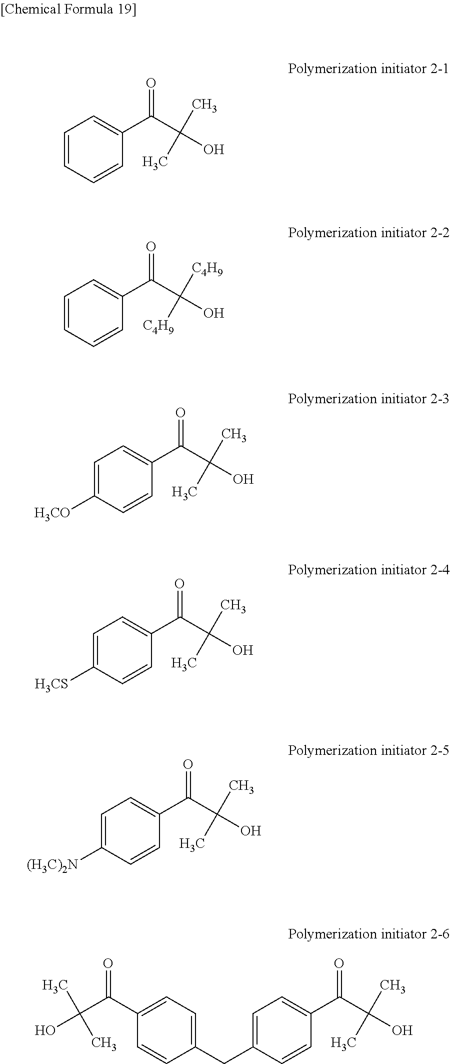

Examples of Acylphosphine Oxide Compound

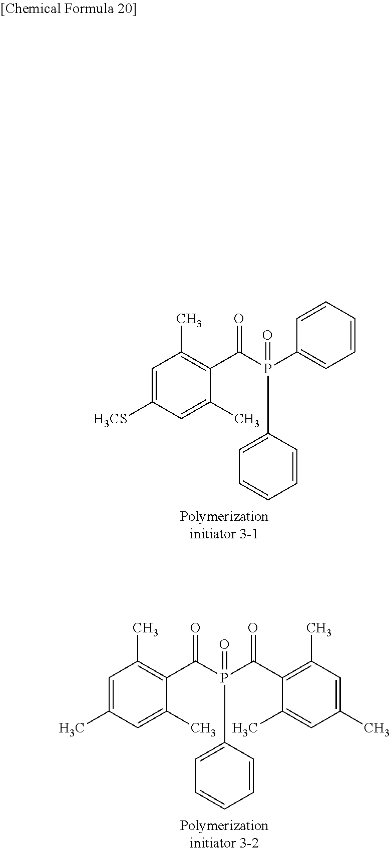

Examples of Other Radical Polymerization Initiators

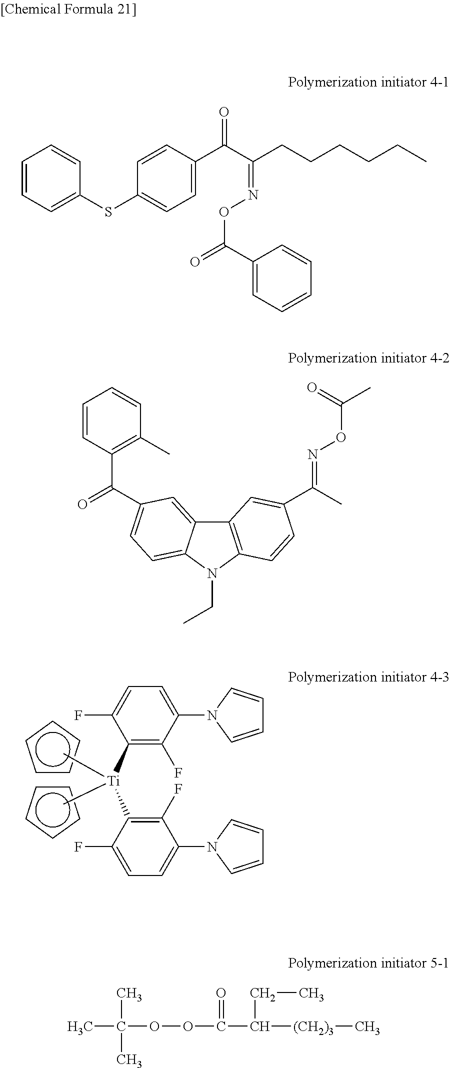

On the other hand, the thermal polymerization initiator may be, for example, a ketone peroxide compound, a peroxyketal compound, a hydroperoxide compound, a dialkyl peroxide compound, a diacyl peroxide compound, a peroxydicarbonate compound, a peroxyester compound, or the like. These thermal polymerization initiators are published in company product catalogues and the like.

The surface protective layer can be formed by a process that includes mixing any of these photopolymerization or thermal polymerization initiators with a composition containing the radically polymerizable compound and other components to form a surface protective layer-forming coating liquid, applying the coating liquid onto the photosensitive layer, and then drying the coating by heating.

One or more of these polymerization initiators may be used alone or in a mixture. The content of the polymerization initiator may be 0.1 to 20 parts by mass, preferably 0.5 to 10 parts by mass, based on 100 parts by mass of the radically polymerizable compound.

(2) Charge Transport Material

In the present invention, the surface protective layer contains a charge transport material including a mixture of two or more stereoisomers.

In the present invention, a compound capable of having two or more stereoisomeric structures is used as a charge transport material. In the present invention, the charge transport material does not consist only of a single stereoisomer but is a mixture of two or more stereoisomers. In the present invention, the stereoisomers include cis-trans isomers with respect to a carbon double bond but do not include cis-trans isomers of any non-aromatic cyclic compound, and no enantiomers will be taken into account.

The charge transport material including such a mixture of two or more stereoisomers can be prevented from crystallizing during the formation of the surface protective layer. This makes it possible to prevent inhibition of the crosslinking reaction of the crosslinking monomer, so that a uniform crosslinked structure can be formed and thus a high-strength surface protective layer with high crack resistance can be obtained.

In addition, the most predominant stereoisomer preferably makes up more than 30% by mass to 60% by mass of all the stereoisomers in the charge transport material. This can increase the potential stability of the electrophotographic photoreceptor. More preferably, the most predominant stereoisomer makes up 45 to 55% by mass of all the stereoisomers. This can further increase the potential stability of the electrophotographic photoreceptor.

The charge transport material is preferably a nonreactive charge-transporting compound that is not reactive with the photo-curable crosslinking monomer and other components, does not deteriorate in the surface protective layer, does not form any bond with the resin in the surface protective layer, and can exist independently.

In the present invention, the surface protective layer may further contain a conventionally known charge transport material in addition to the charge transport material including the mixture of two or more stereoisomers.

(2-1) Compound Having a Structure Represented by Formula (1)

In the present invention, the charge transport material is preferably a compound having a structure represented by formula (1) below. The use of the compound with the structure of formula (1) below makes it possible to increase the transfer memory-preventing effect and potential stability of the electrophotographic photoreceptor.

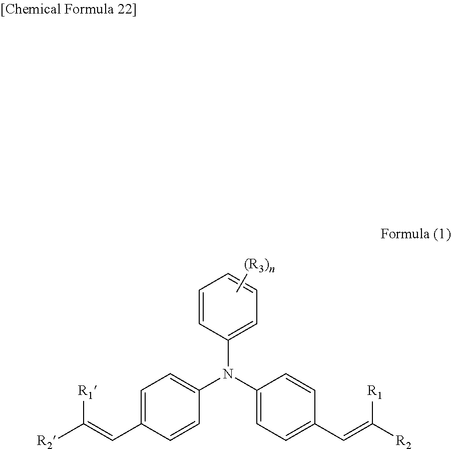

In formula (1), R₁, R₂, R₁′, and R₂′ each independently represent a hydrogen atom or a substituted or unsubstituted aromatic group, R₁≠R₂ and R₁′≠R₂′, R₃ represents a hydrogen atom or an alkyl or alkoxy group of 1 to 4 carbon atoms, and n represents an integer of 1 to 5.

In formula (1), the aromatic groups represented by R₁, R₂, R₁′, and R₂′ may be, for example, aromatic hydrocarbon ring groups (also referred to as aromatic carbon ring groups or aryl groups, such as phenyl, p-chlorophenyl, mesityl, tolyl, xylyl, naphthyl, anthryl, azulenyl, acenaphthenyl, fluorenyl, phenanthryl, indenyl, pyrenyl, and biphenylyl groups) or aromatic heterocyclic groups (such as pyridyl, pyrimidinyl, furyl, pyrrolyl, imidazolyl, benzimidazolyl, pyrazolyl, pyrazinyl, triazolyl (e.g., 1,2,4-triazol-1-yl and 1,2,3-triazol-1-yl), oxazolyl, benzoxazolyl, thiazolyl, isoxazolyl, isothiazolyl, furazanyl, thienyl, quinolyl, benzofuryl, dibenzofuryl, benzothienyl, dibenzothienyl, indolyl, carbazolyl, carbolinyl, diazacarbazolyl (referring to a moiety derived from the carbolinyl by replacing any one of carbon atoms in the carboline ring with a nitrogen atom), quinoxalinyl, pyridazinyl, triazinyl, quinazolinyl, and phthalazinyl groups).

In formula (1), the aromatic groups represented by R₁, R₂, R₁′, and R₂′ may further have any other substituent such as a deuterium atom, a halogen atom, or a cyano, alkyl, alkenyl, alkynyl, alkoxy, carbonyl, amino, silyl, hydroxy, thiol, phosphine oxide, aromatic hydrocarbon ring, aromatic heterocyclic, non-aromatic hydrocarbon ring, non-aromatic heterocyclic, phosphino, sulfonyl, or nitro group, which may be further substituted with any other substituent.

In formula (1), the alkyl group of 1 to 4 carbon atoms represented by R₃ may be, for example, methyl, ethyl, propyl, isopropyl, n-butyl, isobutyl, tert-butyl, or the like. The alkoxy group of 1 to 4 carbon atoms represented by R₃ may be, for example, methoxy, ethoxy, propoxy, isopropoxy, n-butoxy, isobutoxy, tert-butoxy, or the like.

Specific examples of the compound with the structure of formula (1) will be shown below, which, however, should not be construed as limiting the present invention.

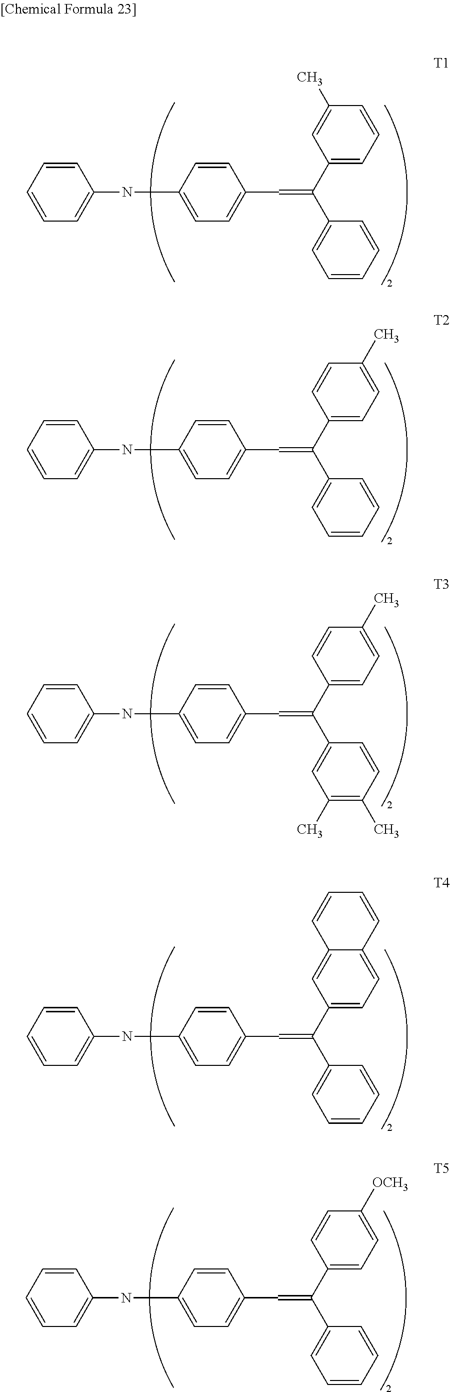

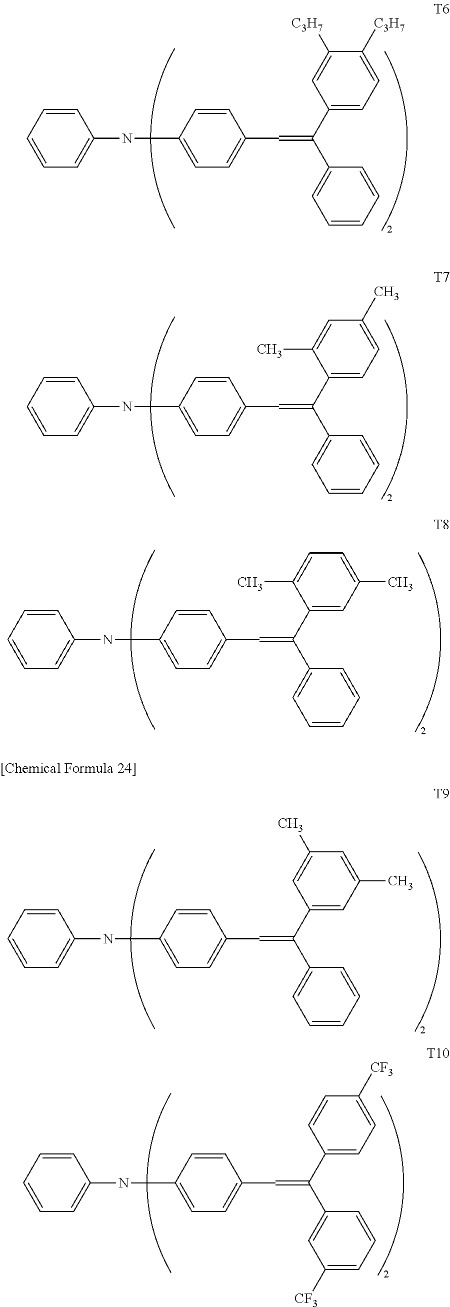

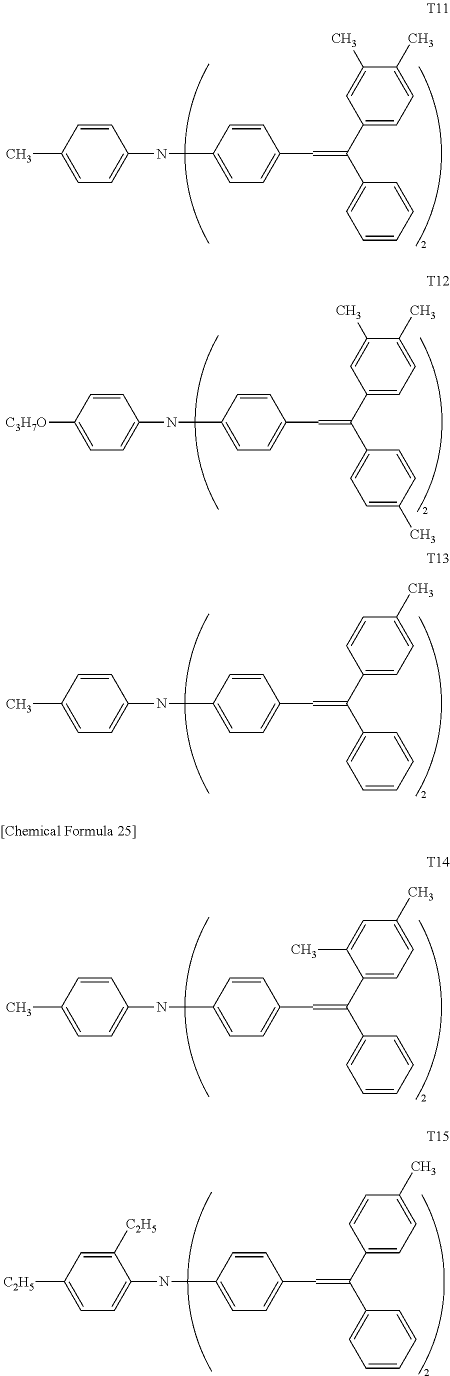

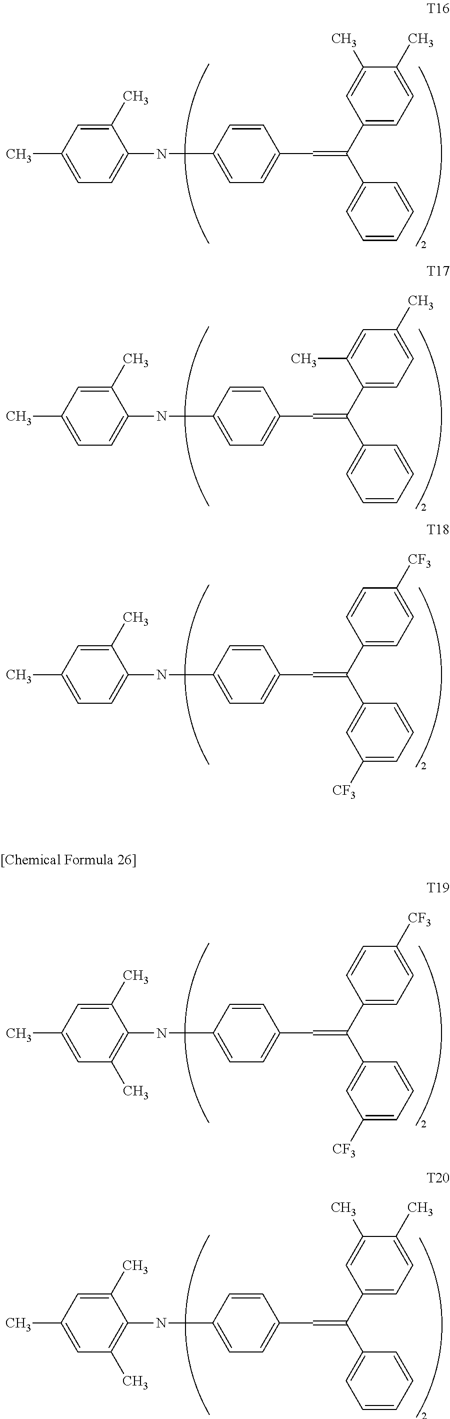

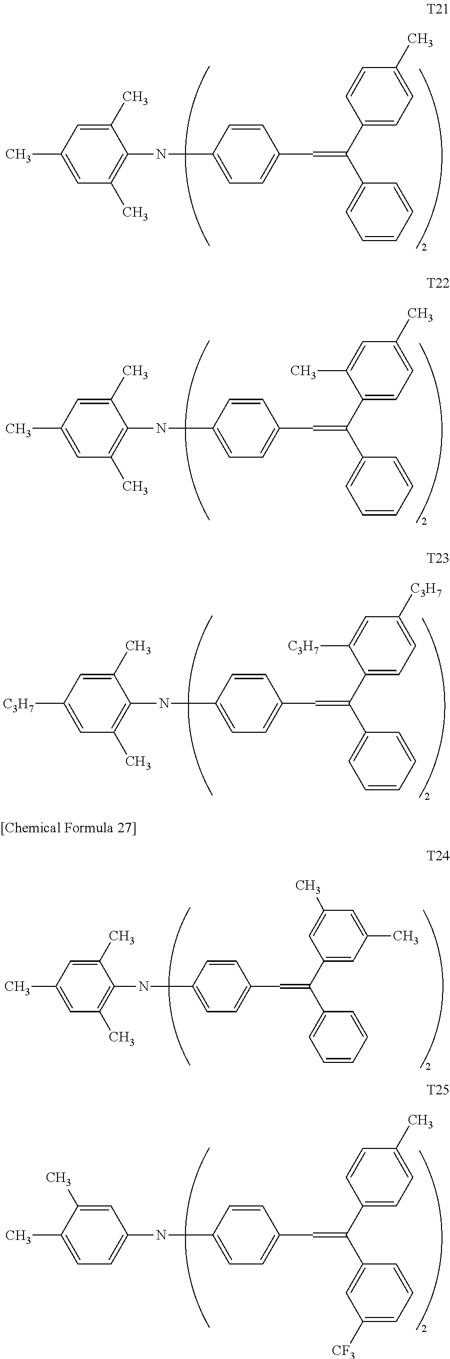

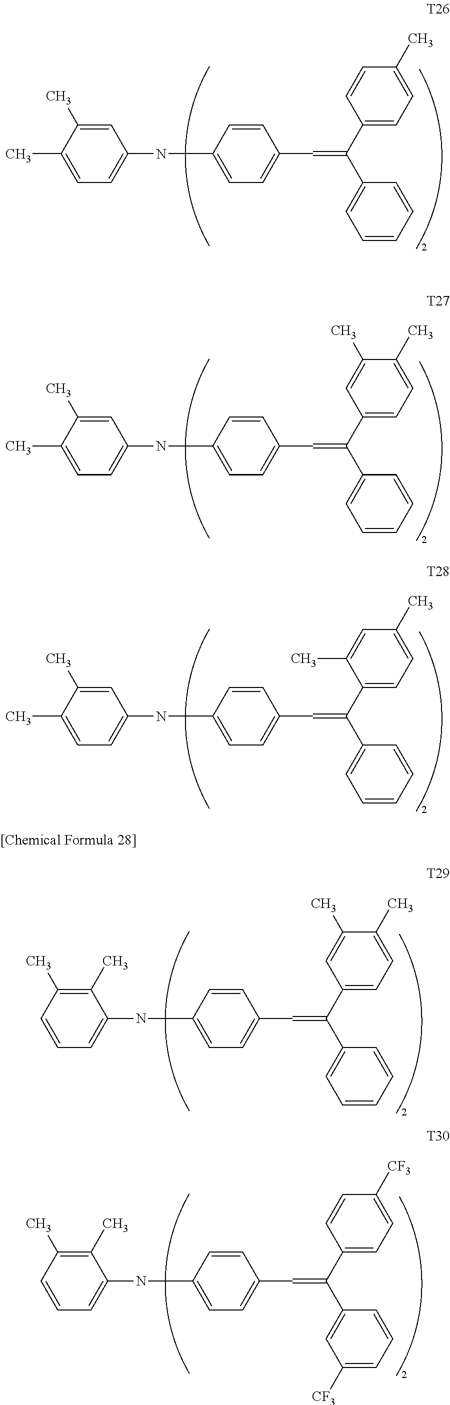

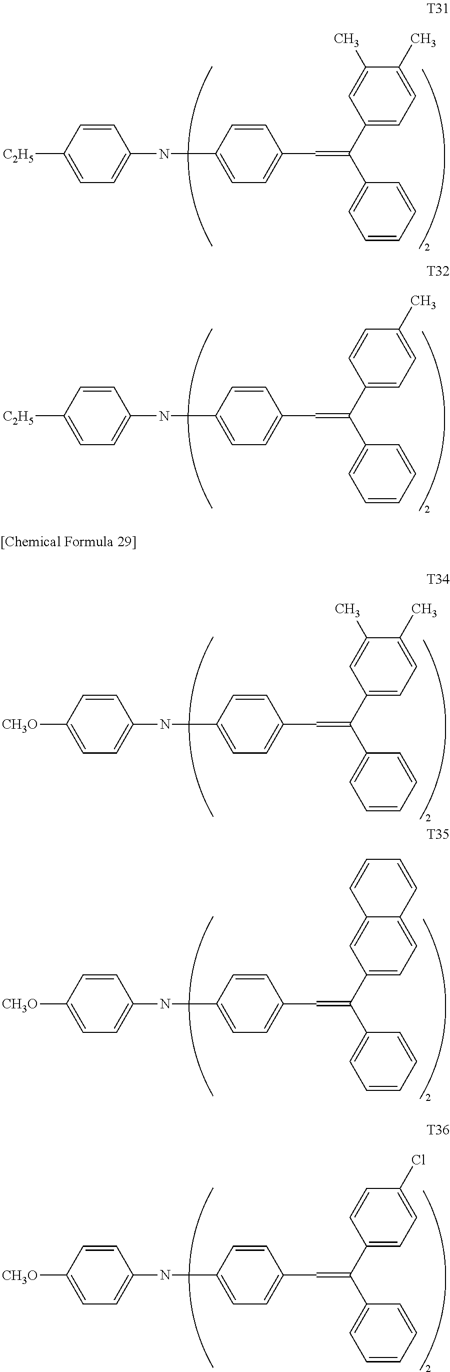

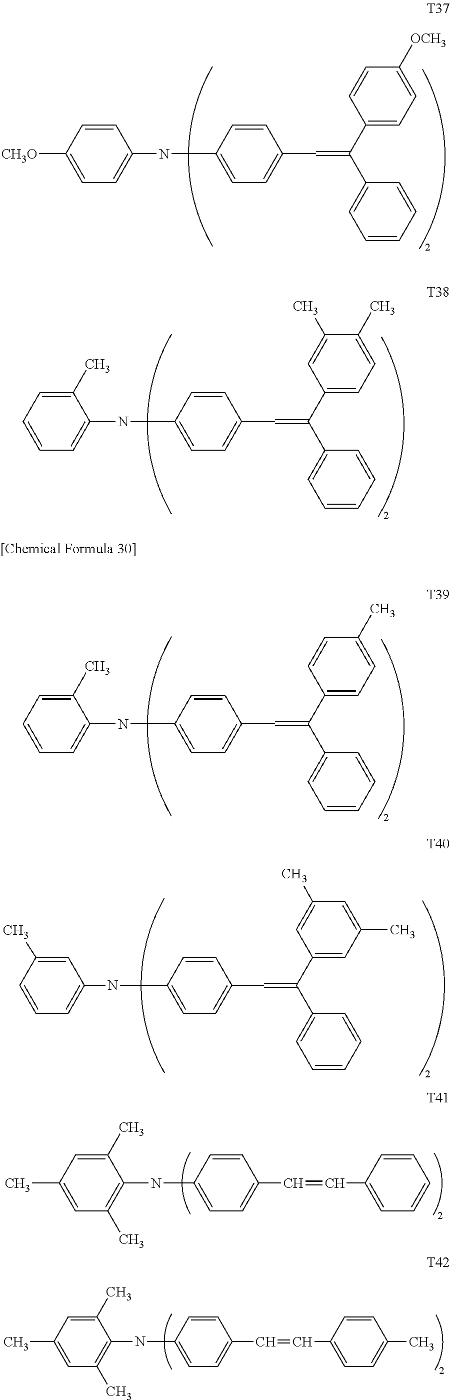

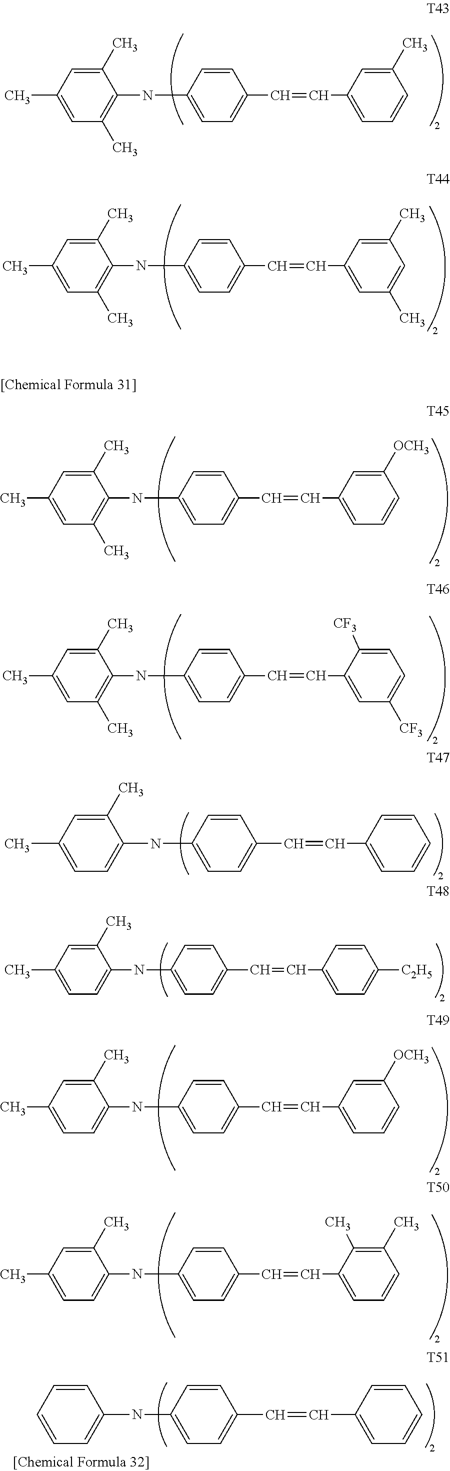

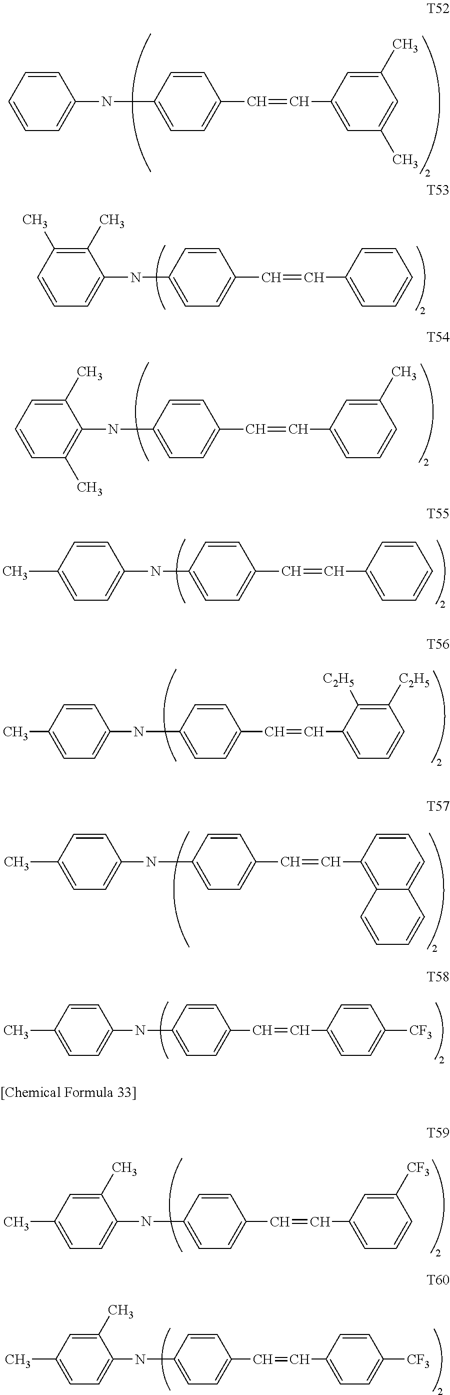

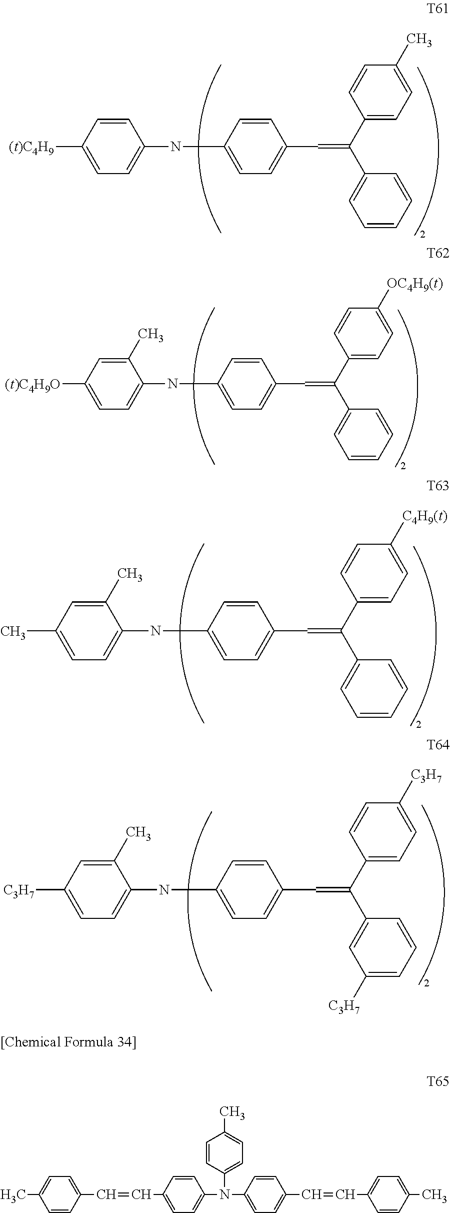

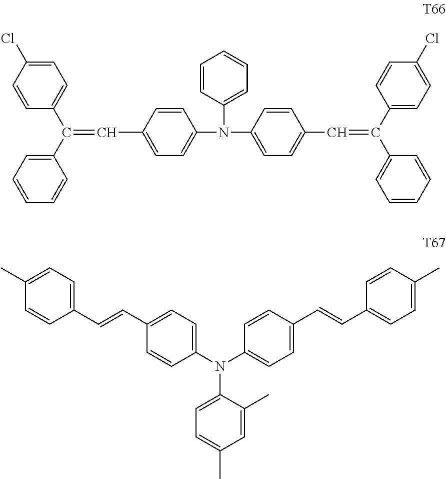

(2-2) Other Compounds

Besides the compound with the structure of formula (1), the charge transport material according to the present invention may include any of the compounds shown below. It will be understood, however, that these examples should not be construed as limiting the present invention.

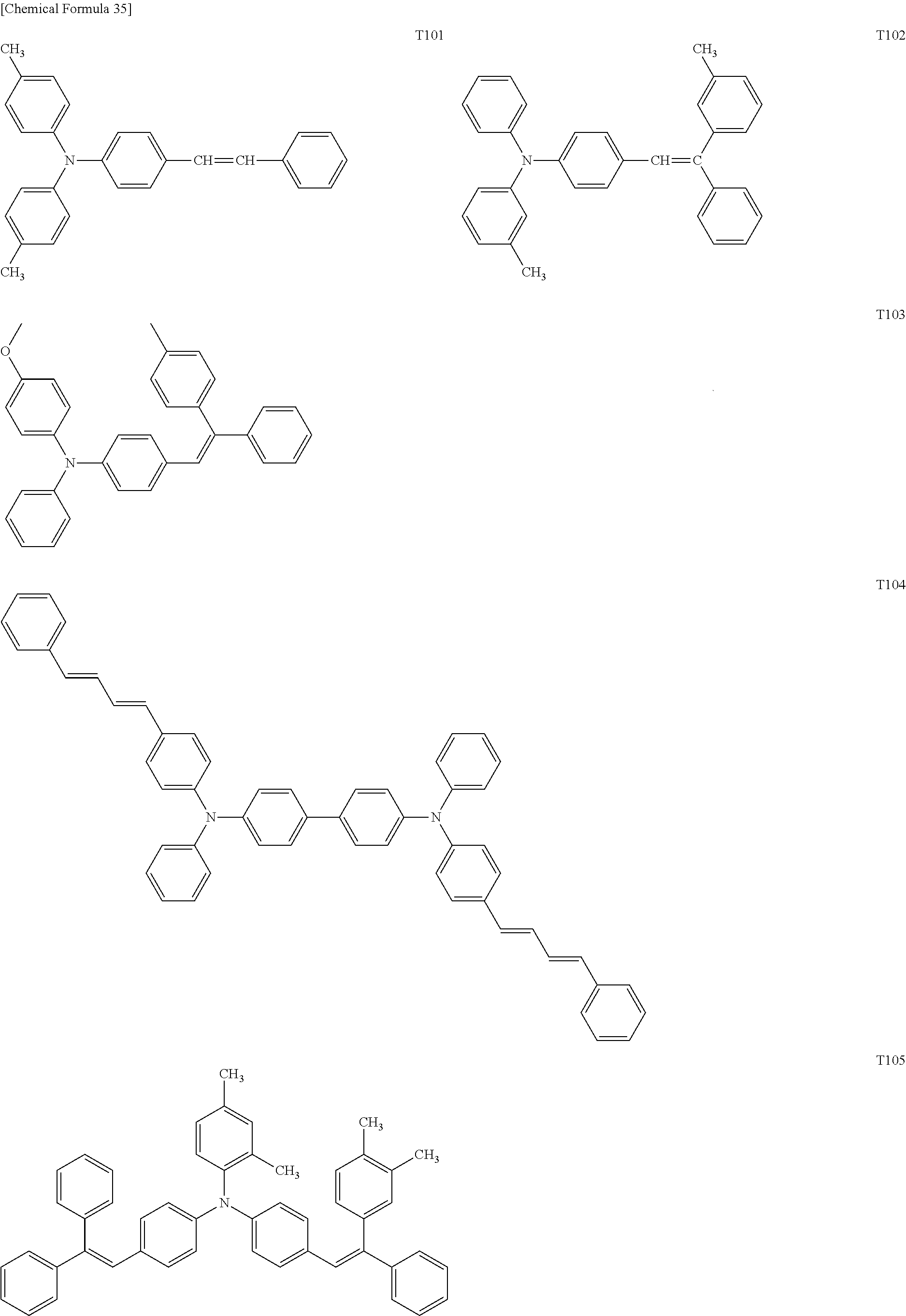 [SMILES: Cc1ccc(N(c2ccc(C)cc2)c2ccc(C=Cc3ccccc3)cc2)cc1 ; Cc1cccc(C(=Cc2ccc(N(c3ccccc3)c3cccc(C)c3)cc2)c2ccccc2)c1 ; COc1ccc(N(c2ccccc2)c2ccc(/C=C(/c3ccccc3)c3ccc(C)cc3)cc2)cc1 ; C(/C=C/c1ccc(N(c2ccccc2)c2ccc(-c3ccc(N(c4ccccc4)c4ccc(/C=C/C=C/c5ccccc5)cc4)cc3)cc2)cc1)=C\c1ccccc1 ; Cc1ccc(N(c2ccc(C=C(c3ccccc3)c3ccccc3)cc2)c2ccc(/C=C(/c3ccccc3)c3ccc(C)c(C)c3)cc2)c(C)c1]

The compound with the structure of formula (1) and other compounds for use as the charge generating material can be synthesized by known synthetic methods such as the synthetic methods described in JP 2010-26428 A and JP 2010-91707 A.

(3) Metal Oxide Particles

In the present invention, the surface protective layer preferably contains metal oxide particles. When metal oxide particles are added to the surface protective layer, a strong surface protective layer can be formed without degradation of the charge-transporting property of the surface protective layer.

The metal oxide particles in the surface protective layer may be particles of an oxide of any of metals including transition metals and other metals. Examples of such particles include particles of silica (silicon oxide), magnesium oxide, zinc oxide, lead oxide, alumina (aluminum oxide), zirconium oxide, tin oxide, titania (titanium oxide), niobium oxide, molybdenum oxide, and vanadium oxides, and other metal oxide particles. Among them, tin oxide, titanium oxide, and zinc oxide are preferred, and tin oxide is particularly preferred.

In the present invention, the method for producing the metal oxide particles is typically, but not limited to, the indirect method (French method) provided in JIS K 1410, the direct method (American method), a plasma technique, or the like.

In the present invention, the metal oxide particles preferably have a number average primary particle size in the range of 1 to 300 nm. In particular, it is preferably 3 to 100 nm.

The number average primary particle size of the metal oxide particles was determined as follows. A photograph of the metal oxide particles was taken at a magnification of 10,000 times with a scanning electron microscope (manufactured by JEOL Ltd.). The photographic images of randomly selected 300 particles (exclusive of agglomerated particles) were input into a scanner. The number average primary particle size of the metal oxide particles was calculated from the input data using an automatic image analyzing system LUZEX AP (NIRECO CORPORATION) with Software Version 1.32.

(4) Method for Forming Surface Protective Layer

The surface protective layer according to the present invention can be formed by a process that includes mixing the photo-curable crosslinking monomer, the charge transport material, the polymerization initiator, and other materials in a solvent to form a composition, applying the composition onto the charge transport layer described below, and then drying and curing the composition. The reaction between the crosslinking monomer molecules proceeds so that the surface protective layer is formed.

The content of the charge transport material in the surface protective layer is preferably 3 to 15% by mass based on 100% by mass of the surface protective layer as a whole.

The content (% by mass) can be determined from the mass of the surface protective layer and the mass of the charge transport material. The mass of the charge transport material can be determined by a process that includes extracting the charge transport material by decomposing the resin layer component of the surface protective layer and measuring the mass of the extracted charge transport material.

In the present invention, the surface protective layer contains the charge transport material, so that the surface protective layer is prevented from trapping charge carriers, which makes it possible to prevent an increase in residual potential and prevent the occurrence of image memory (transfer memory) and the like.

In the present invention, any of various antioxidants or various types of lubricant particles may also be added to the surface protective layer. For example, fluorine atom-containing resin particles may be added to the surface protective layer. Fluorine atom-containing resin particles are preferably, for example, particles of one or more appropriately selected from a tetrafluoroethylene resin, a trifluorochloroethylene resin, a hexafluorochloroethylene-propylene resin, a vinyl fluoride resin, a vinylidene fluoride resin, a difluorodichloroethylene resin, and a copolymer of any of these resins. In particular, a tetrafluoroethylene resin and a vinylidene fluoride resin are preferred.

Examples of the solvent used for the formation of the surface protective layer include, but are not limited to, methanol, ethanol, n-propyl alcohol, isopropyl alcohol, n-butanol, tert-butanol, sec-butanol, benzyl alcohol, toluene, xylene, methylene chloride, methyl ethyl ketone, cyclohexane, ethyl acetate, butyl acetate, methyl cellosolve, ethyl cellosolve, tetrahydrofuran, 1-dioxane, 1,3-dioxolane, pyridine, and diethylamine.

In the present invention, the surface protective layer is preferably formed by a process that includes forming a coating, then subjecting the coating to air drying or thermal drying, and then allowing the coating to react by irradiation with active rays.

The coating method may be a known method such as dip coating, spray coating, spinner coating, bead coating, blade coating, beam coating, or slide hopper coating, similarly to the method for forming the photosensitive layer.

When the electrophotographic photoreceptor of the present invention is produced, the coating is preferably irradiated with active rays to form a cured resin through a process in which radicals are generated to cause polymerization and intermolecular and intramolecular crosslinking reactions to occur to form cross-links for curing. In particular, the active rays are preferably ultraviolet rays or electron beams.

Any ultraviolet light source capable of generating ultraviolet rays may be used with no restriction. Examples that can be used include a low-pressure mercury lamp, a middle-pressure mercury lamp, a high-pressure mercury lamp, an ultrahigh-pressure mercury lamp, a carbon arc lamp, a metal halide lamp, a xenon lamp, and a flash (pulse) xenon lamp. Although the irradiation conditions depend on the type of each lamp, the active ray exposure dose is generally 5 to 500 mJ/cm², preferably 5 to 100 mJ/cm². The lamp power is preferably 0.1 to 5 kW, more preferably 0.5 to 3 kW.

For the electron beam source, any electron beam irradiator may be used. In general, a curtain electron beam accelerator is effectively used for the electron beam irradiation because it can produce a high power at a relatively low cost. In the electron beam irradiation, the acceleration voltage is preferably 100 to 300 kV. The absorbed dose is preferably 0.5 to 10 Mrad.

The irradiation time taken for the necessary active ray exposure dose is preferably 0.1 seconds to 10 minutes, more preferably 0.1 seconds to 5 minutes in view of operation efficiency.

In particular, the active rays are preferably ultraviolet rays, which can be easily used.

When the electrophotographic photoreceptor of the present invention is produced, drying may be performed before, after or during the irradiation with active rays. The timing of drying may be appropriately selected from combinations thereof.

The drying conditions may be appropriately selected depending on the solvent type, the layer thickness, or other factors. The drying temperature is preferably room temperature to 180° C., more preferably 80 to 140° C. The drying time is preferably 1 to 200 minutes, more preferably 5 to 100 minutes.

The surface protective layer preferably has a thickness of 0.2 to 10 μm, more preferably 0.5 to 6 μm.

<<Conductive Support>>

In the present invention, the conductive support may be any material having electrical conductivity, such as a product obtained by forming a metal such as aluminum, copper, chromium, nickel, zinc, or stainless steel into a drum or sheet, a product obtained by laminating a plastic film with a metal foil such as an aluminum or copper foil, a product obtained by vapor-depositing aluminum, indium oxide, or tin oxide on a plastic film, or a metal or plastic film or a paper sheet provided with a conductive layer formed by applying a conductive material alone or a mixture of a conductive material and a binder resin.

<<Intermediate Layer>>

The electrophotographic photoreceptor of the present invention may also include an intermediate layer that is provided between the conductive support and the photosensitive layer and has a barrier function and an adhesive function. The intermediate layer is preferably provided in order to prevent various failures.

The intermediate layer can be formed by, for example, dipping in or coating with a solution of a binder resin such as casein, polyvinyl alcohol, nitrocellulose, ethylene-acrylic acid copolymer, polyamide, polyurethane, or gelatin in a known solvent. In particular, an alcohol-soluble polyamide resin is preferred.

The intermediate layer may also contain inorganic particles, such as any of various types of conductive fine particles or metal oxide particles, for the purpose of controlling its resistance. Examples that can be used include particles of various metal oxides such as alumina, zinc oxide, titanium oxide, tin oxide, antimony oxide, indium oxide, and bismuth oxide, and ultrafine particles of tin-doped indium oxide, antimony-doped tin oxide, zirconium oxide, and the like.

One or more types of these metal oxide particles may be used alone or in a mixture. A mixture of two or more types may be in the form of a solid solution or a fusion. Such metal oxide particles preferably have an average particle size of 0.3 μm or less, more preferably 0.1 μm or less.

The solvent used for the formation of the intermediate layer is preferably one in which inorganic particles are well dispersible and polyamide resin is soluble. For example, alcohols of 2 to 4 carbon atoms, such as ethanol, n-propyl alcohol, isopropyl alcohol, n-butanol, tert-butanol, and sec-butanol are preferred because polyamide resin can have high solubility and high coating ability in them. In order to improve storage stability and the dispersibility of the particles, a co-solvent may be used in combination with the solvent. Examples of such a co-solvent that can produce an advantageous effect include methanol, benzyl alcohol, toluene, methylene chloride, cyclohexanone, and tetrahydrofuran.

The concentration of the binder resin may be appropriately selected depending on the thickness of the intermediate layer and the production rate.

When the inorganic particles or the like are added to the binder resin, the content of the inorganic particles is preferably 20 to 400 parts by mass, more preferably 50 to 200 parts by mass, based on 100 parts by mass of the binder resin.

Examples that can be used as means for dispersing the inorganic particles include, but are not limited to, an ultrasonic disperser, a ball mill, a sand grinder, and a homomixer.

The method for drying the intermediate layer is preferably thermal drying although it may be appropriately selected depending on the solvent type and the layer thickness.

The intermediate layer preferably has a thickness of 0.1 to 15 μm, more preferably 0.3 to 10 μm.

<<Charge Generating Layer>>

The charge generating layer constituting the photosensitive layer according to the present invention preferably includes a charge generating material and a binder resin and is preferably formed by dispersing a charge generating material in a binder resin solution and applying the resulting dispersion.

Examples of the charge generating material include, but are not limited to, azo compounds such as sudan red and dian blue, quinone pigments such as pyrene quinone and anthoanthrone, quinocyanine pigments, perylene pigments, indigo pigments such as indigo and thioindigo, polycyclic quinone pigments such as pyranthrone and diphthaloylpyrene, and phthalocyanine pigments. Any of these charge generating materials may be used alone or in the form of a dispersion in a known resin.

In the charge generating layer, the binder resin may be a known resin, examples of which include, but are not limited to, polystyrene resins, polyethylene resins, polypropylene resins, acrylic resins, methacrylic resins, vinyl chloride resins, vinyl acetate resins, polyvinyl butyral resins, epoxy resins, polyurethane resins, phenolic resins, polyester resins, alkyd resins, polycarbonate resins, silicone resins, melamine resins, copolymer resins including two or more of these resins (such as vinyl chloride-vinyl acetate copolymer resins and vinyl chloride-vinyl acetate-maleic anhydride copolymer resins), and polyvinyl carbazole resins.

The charge generating layer is preferably formed by a process that includes preparing a coating liquid by dispersing, with a disperser, the charge generating material in a solution of the binder resin in a solvent, applying the coating liquid with a constant thickness by using a coater, and drying the coating film.

Examples of the solvent for dissolving and applying the binder resin used to form the charge generating layer include, but are not limited to, toluene, xylene, methylene chloride, 1,2-dichloroethane, methyl ethyl ketone, cyclohexane, ethyl acetate, butyl acetate, methanol, ethanol, propanol, butanol, methyl cellosolve, ethyl cellosolve, tetrahydrofuran, 1-dioxane, 1,3-dioxolane, pyridine, and diethylamine.

Examples that can be used as means for dispersing the charge generating material include, but are not limited to, an ultrasonic disperser, a ball mill, a sand grinder, and a homomixer.

The content of the charge generating material is preferably 1 to 600 parts by mass, more preferably 50 to 500 parts by mass, based on 100 parts by mass of the binder resin. The charge generating layer preferably has a thickness of 0.01 to 5 μm, more preferably 0.05 to 3 μm, although it depends on the properties of the charge generating material, the properties and content of the binder resin, and other factors.

Before the application, the coating liquid for the charge generating layer may be subjected to filtration for removal of contaminants and aggregates, so that the occurrence of image defects can be prevented. Alternatively, the charge generating layer can also be formed by vacuum deposition of the pigment as the charge generating material.

<<Charge Transport Layer>>

The charge transport layer constituting the photosensitive layer according to the present invention includes a charge transport material (CTM) and a binder resin and is formed by dissolving the charge transport material in a binder resin solution and applying the resulting solution.

The charge transport material may be any of various known charge transport materials. Examples include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triarylamine derivatives, phenylenediamine derivatives, stilbene derivatives, benzidine derivatives, poly-N-vinyl carbazole, poly-1-vinyl pyrene, poly-9-vinyl anthracene, and triphenylamine derivatives. Two or more of these materials may be used in the form of a mixture.

The binder resin for use in the charge transport layer may be a known resin, examples of which include polycarbonate resins, polyacrylate resins, polyester resins, polystyrene resins, styrene-acrylonitrile copolymer resins, polymethacrylate resins, and styrene-methacrylate copolymer resins. Among them, polycarbonate is preferred. In addition, BPA, BPZ, dimethyl BPA, BPA-dimethyl BPA copolymers are preferred in view of crack resistance, wear resistance, and charging characteristics.

The charge transport layer is preferably formed by a process that includes preparing a coating liquid by dissolving the binder resin and the charge transport material in a solvent, applying the coating liquid with a constant thickness by using a coater, and drying the coating film.

Examples of the solvent for dissolving the binder resin and the charge transport material include, but are not limited to, toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethylamine.

The content of the charge transport material is preferably 10 to 500 parts by mass, more preferably 20 to 100 parts by mass, based on 100 parts by mass of the binder resin.

The charge transport layer preferably has a thickness of 5 to 40 μm, more preferably 10 to 30 μm, although it depends on the properties of the charge transport material and the properties and content of the binder resin, and other factors.

An antioxidant, an electron conductive agent, a stabilizer, and other materials may be further added to the charge transport layer. An antioxidant, an electron conductive agent, a stabilizer, and other materials may be further added to the charge transport layer. The antioxidant described in JP 2000-305291 A and the electron conductive agent described in JP 50-137543 A or JP 58-76483 A are preferably used.

<<Image Forming Apparatus>>

Next, the image forming apparatus of the present invention using a contact charging mechanism will be described.

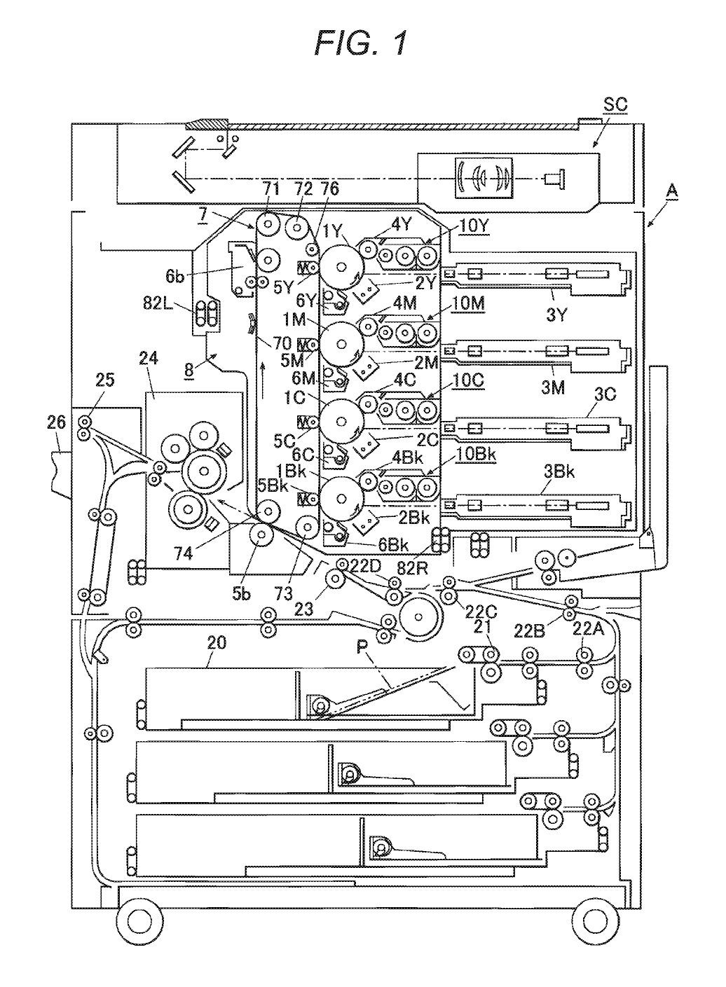

FIG. 1 is a schematic diagram showing a color image forming apparatus according to an embodiment of the present invention.

This color image forming apparatus is what is called a tandem-type color image forming apparatus and includes four image forming parts (image forming units) 10Y, 10M, 10C, and 10Bk, an endless belt-shaped intermediate transfer unit 7, a paper feeder 21, and a fixing unit 24. A document image reader SC is placed on the upper side of the main body A of the image forming apparatus.

The image forming part 10Y for forming a yellow image includes a drum-shaped photoreceptor 1Y as a first image carrier, and a charging unit (charging process) 2Y, an exposure unit (exposure process) 3Y, a developing unit (developing process) 4Y, a primary transfer roller 5Y as a primary transfer unit (primary transfer process), and a cleaning unit 6Y, which are placed around the photoreceptor 1Y. The image forming part 10M for forming a magenta image includes a drum-shaped photoreceptor 1M as a first image carrier, a charging unit 2M, an exposure unit 3M, a developing unit 4M, a primary transfer roller 5M as a primary transfer unit, and a cleaning unit 6M. The image forming part 10C for forming a cyan image includes a drum-shaped photoreceptor 1C as a first image carrier, a charging unit 2C, an exposure unit 3C, a developing unit 4C, a primary transfer roller 5C as a primary transfer unit, and a cleaning unit 6C. The image forming part 10Bk for forming a black image includes a drum-shaped photoreceptor 1Bk as a first image carrier, a charging unit 2Bk, an exposure unit 3Bk, a developing unit 4Bk, a primary transfer roller 5Bk as a primary transfer unit, and a cleaning unit 6Bk. The photoreceptors 1Y, 1M, 1C, and 1Bk each include the electrophotographic photoreceptor of the present invention described above.

The four image forming units 10Y, 10M, 10C, and 10Bk include the photoreceptors 1Y, 1M, 1C, and 1Bk at the center, charging units 2Y, 2M, 2C, and 2Bk, exposure units 3Y, 3M, 3C, and 3Bk, rotatable developing units 4Y, 4M, 4C, and 4Bk, and cleaning units 6Y, 6M, 6C, and 6Bk for cleaning the photoreceptors 1Y, 1M, 1C, and 1Bk, respectively.

The image forming units 10Y, 10M, 10C, and 10Bk have the same structure, except that the toner images to be formed on the photoreceptors 1Y, 1M, 1C, and 1Bk, respectively, differ in color. Therefore, the structure will be described in detail using the image forming unit 10Y as an example.

The image forming unit 10Y includes the photoreceptor 1Y as an image forming medium, and the charging unit 2Y, the exposure unit 3Y, the developing unit 4Y, and the cleaning unit 6Y, which are placed around the photoreceptor 1Y. The image forming unit 10Y is configured to form a yellow (Y) toner image on the photoreceptor 1Y. In this embodiment, at least the photoreceptor 1Y, the charging unit 2Y, the developing unit 4Y, and the cleaning unit 6Y are integrally provided in the image forming unit 10Y.

The charging unit 2Y is a unit configured to apply a uniform potential to the photoreceptor 1Y. In this embodiment, a corona discharge-type charger is used.

The exposure unit 3Y is a unit configured to expose, to light, the photoreceptor 1Y provided with a uniform potential from the charging unit 2Y, based on an image signal (yellow) so that an electrostatic latent image corresponding to a yellow image can be formed. The exposure unit 3Y may be a unit including a focusing device and an LED having light emitting elements arranged in an array along the axis direction of the photoreceptor 1Y, or the exposure unit 3Y may be a unit including a laser optical system.

In the image forming apparatus of the present invention, some components including the photoreceptor, the developing unit, and the cleaning unit may be integrated to form a process cartridge (image forming unit), and this image forming unit may be detachably attached to the main part of the apparatus. Alternatively, the photoreceptor and at least one of the charging unit, the exposure unit, the developing unit, the transfer or separation unit, and the cleaning unit may be integrally supported to form a process cartridge (image forming unit), which may be detachably attached as a single image forming unit to the main part of the apparatus though a guide member such as a rail in the main part of the apparatus.

An endless belt-shaped intermediate transfer unit 7 has an endless belt-shaped intermediate transfer medium 70, which is a second image carrier of a semiconducting endless belt and wound and rotatably supported by a plurality of rollers.

The respective color images formed by the image forming units 10Y, 10M, 10C, and 10Bk are sequentially transferred onto the rotating endless belt-shaped intermediate transfer medium 70 by the primary transfer rollers 5Y, 5M, 5C, and 5Bk as primary transfer units to form a composite color image. An image support P as a transfer material (e.g., an image support capable of carrying the final fixed image, such as a plain paper sheet or a transparent sheet), which is stored in a paper feeding cassette 20, is fed by the paper feeder 21 and transported to a secondary transfer roller 5b as a secondary transfer unit through a plurality of intermediate rollers 22A, 22B, 22C, and 22D and a resist roller 23, and the color images are transferred at a time onto the image support P by secondary transfer. The image support P with the color images transferred thereon is subjected to fixation by the fixing unit 24 and then placed on a discharge tray 26 by being held between discharge rollers 25. Herein, transfer supports for toner images formed on photoreceptors, such as intermediate transfer media and image supports are generically referred to as “transfer media.”

On the other hand, after the color images are transferred onto the image support P by the secondary transfer roller 5b as a secondary transfer unit, the residual toner is removed by the cleaning unit 6b from the endless belt-shaped intermediate transfer medium 70, from which the image support P has been self-stripped.

During the image forming process, the primary transfer roller 5Bk is constantly in contact with the photoreceptor 1Bk. The other primary transfer rollers 5Y, 5M, and 5C come into contact with the corresponding photoreceptors 1Y, 1M, and 1C, respectively only when the color image is formed.

The secondary transfer roller 5b comes into contact with the endless belt-shaped intermediate transfer medium 70 only when the image support P passes through the secondary transfer roller 5b so that the secondary transfer is performed.

A case 8 is so provided that it can be pulled out of the main body A of the apparatus through a support rail 82L.

The case 8 contains the image forming parts 10Y, 10M, 10C, and 10Bk and the endless belt-shaped intermediate transfer unit 7.

The image forming parts 10Y, 10M, 10C, and 10Bk are vertically arranged in tandem. As illustrated, the endless belt-shaped intermediate transfer unit 7 is located on the left of the photoreceptors 1Y, 1M, 1C, and 1Bk. The endless belt-shaped intermediate transfer unit 7 includes the endless belt-shaped intermediate transfer medium 70 that is wound and rotatable around the rollers 71, 72, 73, 74, and 76, the primary transfer rollers 5Y, 5M, 5C, and 5Bk, the cleaning unit 6b, and other components.

Although the image forming apparatus shown in FIG. 1 is a color laser printer, it will be understood that the disclosure is also applicable to monochrome laser printers and copiers. Alternatively, a light source other than the laser, such as an LED light source may also be used as the exposure light source.

### EXAMPLES

Hereinafter, the present invention will be more specifically described with reference to examples, which, however, are not intended to limit the present invention. As used in the examples, “%” refers to “% by mass,” unless otherwise specified.

<<Preparation of Charge Transport Materials T20-1 to 120-8>>

First, illustrative compound T20 shown above was synthesized as described below.

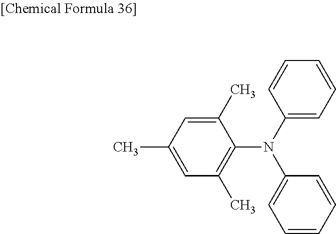 [SMILES: Cc1cc(C)c(N(c2ccccc2)c2ccccc2)c(C)c1]

In 32 g of phosphorus oxychloride was dissolved 10 g of the compound represented by the above structural formula. The solution was heated to 50° C., and 22 ml of dimethylformamide was gradually added dropwise to the heated solution (the temperature rose to 40 to 70° C. due to heat generation). The reaction liquid was stirred for 15 hours while kept at around 90° C. After the reaction liquid was allowed to cool to 40° C., excess phosphorus oxychloride was sufficiently hydrolyzed. The resulting precipitated crystals were separated by filtration and then washed by being suspended in water. After the washing was repeated until the wash liquid became neutral, 9.25 g (yield 77%) of a bisformyl compound represented by the structural formula below was obtained.

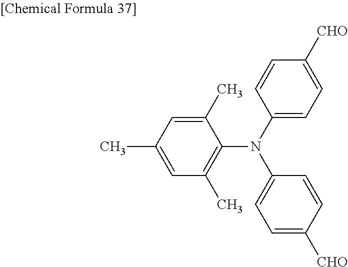 [SMILES: Cc1cc(C)c(N(c2ccc(C=O)cc2)c2ccc(C=O)cc2)c(C)c1]

Subsequently, 2 g of the resulting bisformyl compound and 4.3 g of a phosphonate compound represented by the structural formula below were dissolved in 20 ml of dimethylformamide. While the reaction liquid was kept at around 20° C., 1.0 g of sodium methoxide was gradually added thereto (heat generation occurred). After stirring for 4 hours, 30 ml of water was added to the reaction mixture. The mixture was subjected to purification by conventional methods to give 3.3 g (yield 81%) of yellow crystals. Elemental analysis and mass spectrometry showed that the yellow crystals were illustrative compound T20.

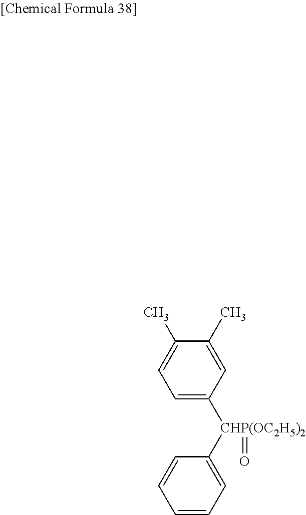

Illustrative compound T20 obtained by the synthesis was designated as charge transport material T20-1. Charge transport material T20-1 was analyzed by liquid chromatography (HPLC) under the conditions shown below. As a result, the cis-cis form (hereinafter referred to as T20cis-cis), the cis-trans form (hereinafter referred to as T20cis-trans), and the trans-trans form (hereinafter referred to as T20trans-trans) were found to exist in a mass ratio of 1.0/2.1/1.0. In this regard, the structural formula of each of T20cis-cis, T20cis-trans, and T20trans-trans is shown below.

Conditions for Liquid Chromatography Measurement

Analyzer: Shimadzu LC6A (manufactured by Shimadzu Corporation)

Column: CLC-SIL (manufactured by Shimadzu Corporation)

Detection wavelength: 290 nm

Mobile phase: n-hexane/dioxane=10-500/1

Mobile phase flow rate: about 1 ml/minute

Sample (charge transport material T20-1)

Solvent: n-hexane/dioxane=10/1

Sample (charge transport material T20-1): 3 mg/solvent 10 ml

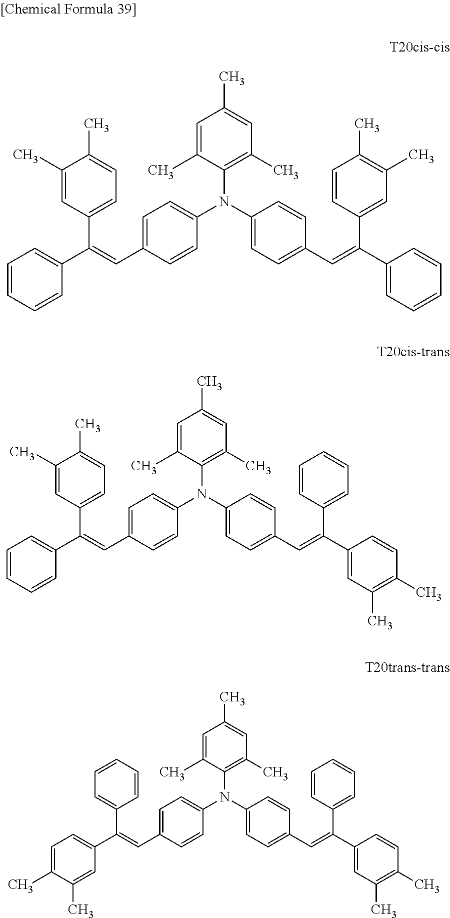

In the present invention, when different substituents are bonded to the carbon atoms of a carbon-carbon double bond, a structure with higher molecular weight substituents located on the same side (among the substituents bonded to the carbon atoms) is referred to as cis, and a structure with higher molecular weight substituents located on opposite sides is referred to as trans. When different substituents are bonded to the adjacent carbon atoms of a cyclic compound, a structure with higher molecular weight substituents located on the same side of the ring plane (among the substituents bonded to the adjacent carbon atoms) is referred to as cis, and a structure with higher molecular weight substituents located on opposite sides of the ring plane is referred to as trans.

Subsequently, T20cis-cis, T20cis-trans, and T20trans-trans were isolated from the resulting charge transport material T20-1 by liquid chromatography. Charge transport materials T20-2 to T20-8 were then prepared by mixing them in different mass ratios as shown in Table 1.

The content (% by mass) of the most predominant stereoisomer in each of charge transport materials T20-1 to T20-8 was calculated based on the mass of all the stereoisomers in each of charge transport materials T20-1 to T20-8. Table 1 shows the calculated values.

<<Preparation of Charge Transport Materials T50-1 to T50-8>>

First, illustrative compound T50 shown above was synthesized as described below.

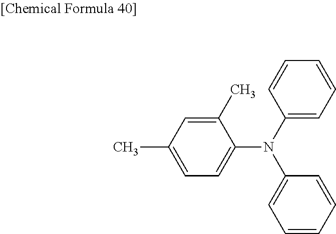 [SMILES: Cc1ccc(N(c2ccccc2)c2ccccc2)c(C)c1]

In 34 g of phosphorus oxychloride was dissolved 10 g of the compound represented by the above structural formula. The solution was heated to 50° C., and 23 ml of dimethylformamide was gradually added dropwise to the heated solution (the temperature rose to 40 to 70° C. due to heat generation). The reaction liquid was stirred for 15 hours while kept at around 90° C. After the reaction liquid was allowed to cool to 40° C., excess phosphorus oxychloride was sufficiently hydrolyzed. The resulting precipitated crystals were separated by filtration and then washed by being suspended in water. After the washing was repeated until the wash liquid became neutral, 9.43 g (yield 78%) of a bisformyl compound represented by the structural formula below was obtained.

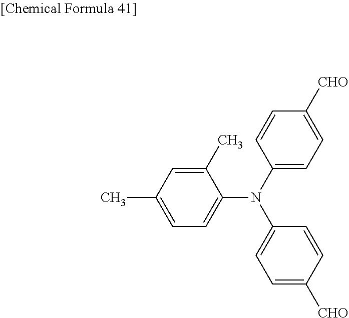 [SMILES: Cc1ccc(N(c2ccc(C=O)cc2)c2ccc(C=O)cc2)c(C)c1]

Subsequently, 2 g of the resulting bisformyl compound and 4.3 g of a phosphonate compound represented by the structural formula below were dissolved in 20 ml of dimethylformamide. While the reaction liquid was kept at around 20° C., 1.0 g of sodium methoxide was gradually added thereto (heat generation occurred). After stirring for 4 hours, 30 ml of water was added to the reaction mixture. The mixture was subjected to purification by conventional methods to give 3.3 g (yield 81%) of yellow crystals. Elemental analysis and mass spectrometry showed that the yellow crystals were illustrative compound T50.

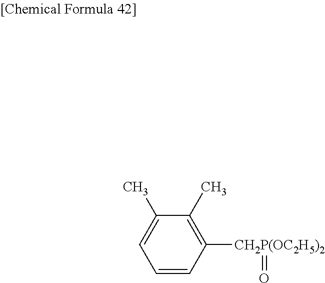

Illustrative compound T50 obtained by the synthesis was designated as charge transport material T50-1. Charge transport material T50-1 was analyzed by liquid chromatography (HPLC) under the same conditions as for charge transport materials T20-1 to T20-8 above. As a result, the cis-cis form (hereinafter referred to as T50cis-cis), the cis-trans form (hereinafter referred to as T50cis-trans), and the trans-trans form (hereinafter referred to as T50trans-trans) were found to exist in a mass ratio of 1.1/2.2/1.0. In this regard, the structural formula of each of T50cis-cis, T50cis-trans, and T50trans-trans is shown below.

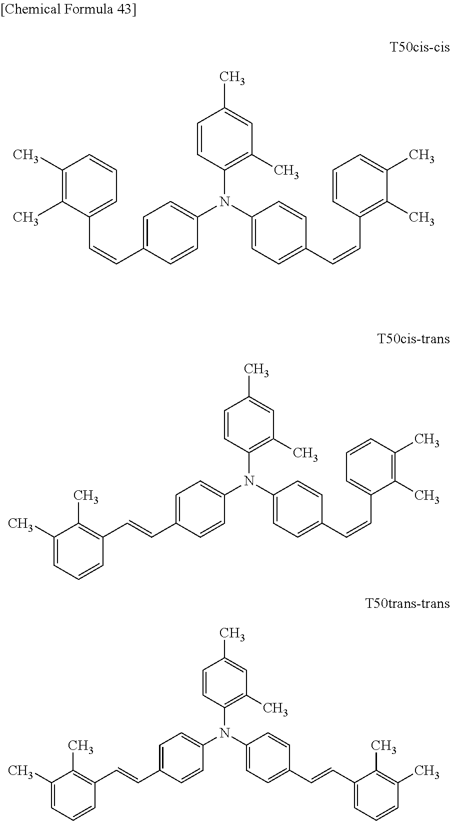

Subsequently, T50cis-cis, T50cis-trans, and T50trans-trans were isolated from the resulting charge transport material T50-1 by liquid chromatography. Charge transport materials T50-2 to T50-8 were then prepared by mixing them in different mass ratios as shown in Table 1.

The content (% by mass) of the most predominant stereoisomer in each of charge transport materials T50-1 to T50-8 was calculated based on the mass of all the stereoisomers in each of charge transport materials T50-1 to T50-8. Table 1 shows the calculated values.

<<Preparation of Charge Transport Material T105-1>>

First, illustrative compound T105 shown above was prepared as described below.

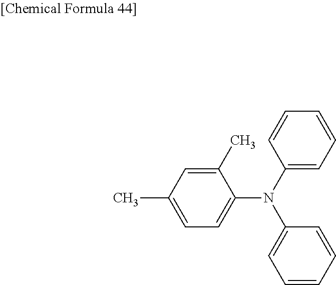 [SMILES: Cc1ccc(N(c2ccccc2)c2ccccc2)c(C)c1]

In 34 g of phosphorus oxychloride was dissolved 10 g of the compound represented by the above structural formula (2,4-dimethyl-N,N-diphenylaniline). The solution was heated to 50° C., and 25 ml of dimethylformamide was gradually added dropwise to the heated solution (the temperature rose to 40 to 70° C. due to heat generation). The reaction liquid was stirred for 15 hours while kept at around 90° C. After the reaction liquid was allowed to cool to 40° C., excess phosphorus oxychloride was sufficiently hydrolyzed. The resulting precipitated crystals were separated by filtration and then washed by being suspended in water. After the washing was repeated until the wash liquid became neutral, 11.1 g (yield 92%) of a bisformyl compound represented by the structural formula below was obtained.

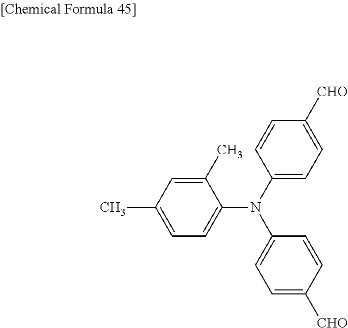 [SMILES: Cc1ccc(N(c2ccc(C=O)cc2)c2ccc(C=O)cc2)c(C)c1]

Subsequently, 5 g of the resulting bisformyl compound, 5.3 g of phosphonate compound 1 (diethyl benzhydrylphosphonate), and 5.8 g of phosphonate compound 2 (diethyl((3,4-dimethylphenyl) (phenyl)methyl)phosphonate), represented by the structural formulae below, were dissolved in 20 ml of dimethylformamide. While the reaction liquid was kept at around 20° C., 2.6 g of sodium methoxide was gradually added thereto (heat generation occurred). After stirring for 4 hours, 30 ml of water was added to the reaction mixture. The mixture was subjected to purification by conventional methods to give 6.8 g (yield 68%) of yellow crystals. Elemental analysis and mass spectrometry showed that the yellow crystals were illustrative compound T105.

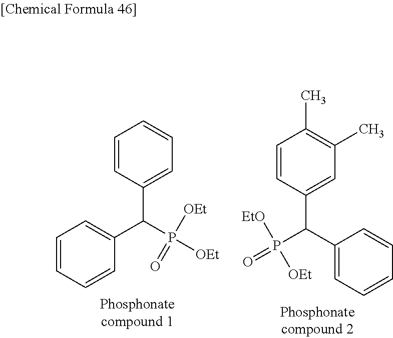 [SMILES: CCOP(=O)(OCC)C(c1ccccc1)c1ccccc1 ; CCOP(=O)(OCC)C(c1ccccc1)c1ccc(C)c(C)c1]

Illustrative compound T105 obtained by the synthesis was designated as charge transport material T105-1. Charge transport material T105-1 was analyzed by liquid chromatography (HPLC) under the same conditions as for charge transport materials 120-1 to T20-8 above. As a result, the cis form (hereinafter referred to as T105cis) and the trans form (hereinafter referred to as T105trans) were found to exist in a mass ratio of 1.00/1.11. In this regard, the structural formulae of T105cis and T105trans are shown below.

The content (% by mass) of the most predominant stereoisomer was also calculated based on the mass of all the stereoisomers in charge transport material T105-1. Table 1 shows the calculated value.

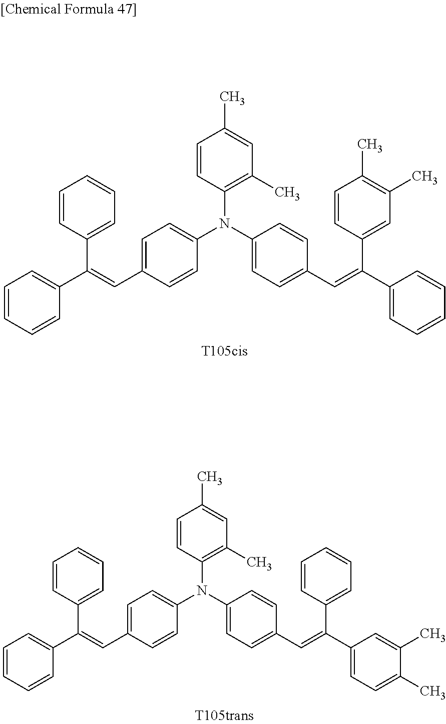 [SMILES: Cc1ccc(N(c2ccc(C=C(c3ccccc3)c3ccccc3)cc2)c2ccc(/C=C(/c3ccccc3)c3ccc(C)c(C)c3)cc2)c(C)c1 ; Cc1ccc(N(c2ccc(C=C(c3ccccc3)c3ccccc3)cc2)c2ccc(/C=C(\c3ccccc3)c3ccc(C)c(C)c3)cc2)c(C)c1]

<<Preparation of Charge Transport Materials T1-1 and T1-2>>

Illustrative compound T1 was prepared by the same method as in the preparation of illustrative compound T105, except that 2,4-dimethyl-N,N-diphenylaniline was replaced with amine compound 1 represented by the structural formula below and phosphonate compounds 1 and 2 were replaced with phosphonate compounds 3 and 4 represented by the structural formulae below, respectively.

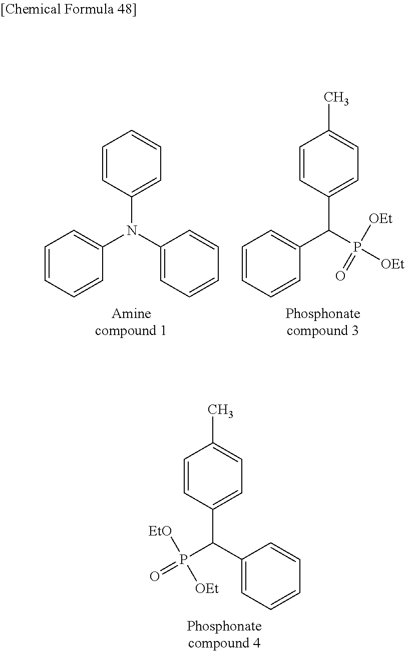

Illustrative compound T1 obtained by the synthesis was designated as charge transport material T1-1. Charge transport material T1-1 was analyzed by liquid chromatography (HPLC) under the same conditions as for charge transport materials T20-1 to T20-8 above. As a result, the cis-cis form (hereinafter referred to as T1cis-cis), the cis-trans form (hereinafter referred to as T1cis-trans), and the trans-trans form (hereinafter referred to as T1trans-trans) were found to exist in a mass ratio of 1.0/2.1/1.0.

Subsequently, T1cis-cis, T1cis-trans, and T1trans-trans were isolated from the resulting charge transport material T1-1 by liquid chromatography. Charge transport material T1-2 was then prepared by mixing them in a different mass ratio as shown in Table 1.

The content (% by mass) of the most predominant stereoisomer in each of charge transport materials T1-1 and T1-2 was calculated based on the mass of all the stereoisomers in each of charge transport materials T1-1 and T1-2. Table 1 shows the calculated values.

<<Preparation of Charge Transport Materials T11-1 and T11-2>>

Illustrative compound T11 was prepared by the same method as in the preparation of illustrative compound T105, except that 2,4-dimethyl-N,N-diphenylaniline was replaced with amine compound 2 represented by the structural formula below and phosphonate compounds 1 and 2 were replaced with phosphonate compounds 5 and 6 represented by the structural formulae below, respectively.

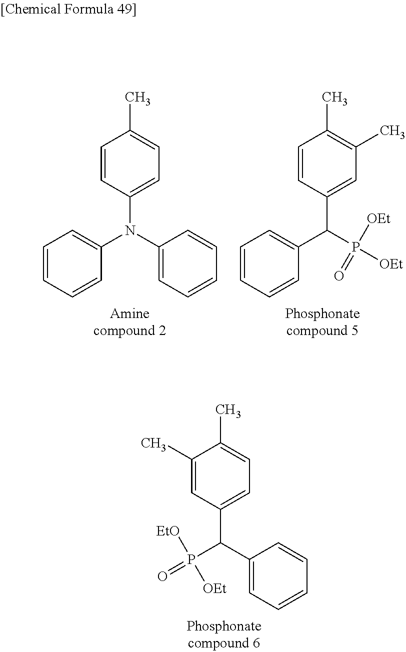

Illustrative compound T11 obtained by the synthesis was designated as charge transport material T11-1. Charge transport material T11-1 was analyzed by liquid chromatography (HPLC) under the same conditions as for charge transport materials T20-1 to T20-8 above. As a result, the cis-cis form (hereinafter referred to as T11cis-cis), the cis-trans form (hereinafter referred to as T11cis-trans), and the trans-trans form (hereinafter referred to as T11trans-trans) were found to exist in a mass ratio of 1.0/2.1/1.0.

Subsequently, T11cis-cis, T11cis-trans, and T11trans-trans were isolated from the resulting charge transport material T11-1 by liquid chromatography. Charge transport material T11-2 was then prepared by mixing them in a different mass ratio as shown in Table 1.

The content (% by mass) of the most predominant stereoisomer in each of charge transport materials T11-1 and T11-2 was calculated based on the mass of all the stereoisomers in each of charge transport materials T11-1 and T11-2. Table 1 shows the calculated values.

<<Preparation of Charge Transport Materials T12-1 and T12-2>>

Illustrative compound T12 was prepared by the same method as in the preparation of illustrative compound T105, except that 2,4-dimethyl-N,N-diphenylaniline was replaced with amine compound 3 represented by the structural formula below and phosphonate compounds 1 and 2 were replaced with phosphonate compounds 7 and 8 represented by the structural formulae below, respectively.

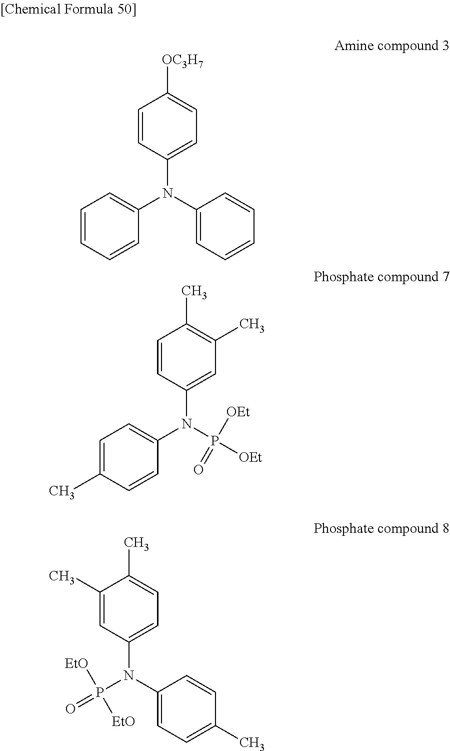

Illustrative compound T12 obtained by the synthesis was designated as charge transport material T12-1. Charge transport material T12-1 was analyzed by liquid chromatography (HPLC) under the same conditions as for charge transport materials T20-1 to T20-8 above. As a result, the cis-cis form (hereinafter referred to as T12cis-cis), the cis-trans form (hereinafter referred to as T12cis-trans), and the trans-trans form (hereinafter referred to as T12trans-trans) were found to exist in a mass ratio of 1.0/2.1/1.0.

Subsequently, T12cis-cis, T12cis-trans, and T12trans-trans were isolated from the resulting charge transport material T12-1 by liquid chromatography. Charge transport material T12-2 was then prepared by mixing them in a different mass ratio as shown in Table 1.

The content (% by mass) of the most predominant stereoisomer in each of charge transport materials T12-1 and T12-2 was calculated based on the mass of all the stereoisomers in each of charge transport materials T12-1 and T12-2. Table 1 shows the calculated values.

<<Preparation of Charge Transport Materials T61-1 and T61-2>>

Illustrative compound T61 was prepared by the same method as in the preparation of illustrative compound T105, except that 2,4-dimethyl-N,N-diphenylaniline was replaced with amine compound 4 represented by the structural formula below and phosphonate compounds 1 and 2 were replaced with phosphonate compounds 3 and 4 shown above, respectively.

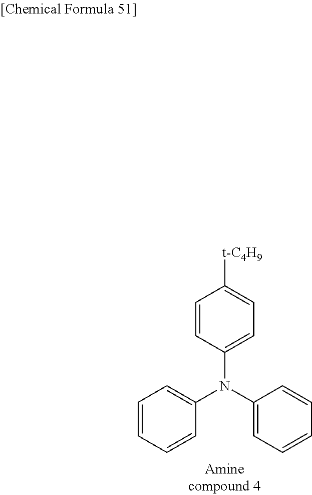

Illustrative compound T61 obtained by the synthesis was designated as charge transport material T61-1. Charge transport material T61-1 was analyzed by liquid chromatography (HPLC) under the same conditions as for charge transport materials T20-1 to T20-8 above. As a result, the cis-cis form (hereinafter referred to as T61cis-cis), the cis-trans form (hereinafter referred to as T61cis-trans), and the trans-trans form (hereinafter referred to as T61trans-trans) were found to exist in a mass ratio of 1.0/2.1/1.0.

Subsequently, T61cis-cis, T61cis-trans, and T61trans-trans were isolated from the resulting charge transport material T61-1 by liquid chromatography. Charge transport material T61-2 was then prepared by mixing them in a different mass ratio as shown in Table 1.

The content (% by mass) of the most predominant stereoisomer in each of charge transport materials T61-1 and T61-2 was calculated based on the mass of all the stereoisomers in each of charge transport materials T61-1 and T61-2. Table 1 shows the calculated values.

<<Preparation of Electrophotographic Photoreceptor 1>>

(Preparation of Conductive Support)

A conductive support was prepared by cutting the surface of a cylindrical aluminum support with a diameter of 60 mm.

(Formation of Intermediate Layer)

A dispersion with the composition shown below was diluted 2-fold with the same solvent. The dilution was allowed to stand overnight and then filtered (with a 5 μm Rigimesh Filter manufactured by Pall Corporation) to give an intermediate layer-forming coating liquid.

Polyamide resin CM8000 (manufactured by Toray Industries, Inc.) 1 part by mass

Titanium oxide SMT500SAS (manufactured by Tayca Corporation) 3 parts by mass

Methanol 10 parts by mass

In a batch mode, the materials were dispersed for 10 hours using a sand mill as a disperser.

The intermediate layer-forming coating liquid prepared was applied onto the conductive support by dip coating, so that an intermediate layer with a dry thickness of 2 μm was formed.

(Formation of Charge Generating Layer)

Charge generating material: Y-TiPh (a titanyl phthalocyanine pigment having a maximum diffraction peak at least at 27.3° in Cu-Kα characteristic X-ray diffraction spectroscopy) 20 parts by mass

Polyvinyl butyral resin (#6000-C manufactured by Denka Company Limited) 10 parts by mass

Tert-butyl acetate 700 parts by mass

4-methoxy-4-methyl-2-pentanone 300 parts by mass

The materials were mixed and dispersed for 10 hours with a sand mill to form a charge generating layer-forming coating liquid. The charge generating layer-forming coating liquid prepared was applied onto the intermediate layer by dip coating, so that a charge generating layer with a dry thickness of 0.3 μm was formed.

(Formation of Charge Transport Layer)

Charge Transport Material:

4,4′-dimethyl-4″-(β-phenylstyryl)triphenylamine 225 parts by mass

Binder: Polycarbonate Z (Z300 manufactured by MITSUBISHI GAS CHEMICAL COMPANY, INC.) 300 parts by mass

Antioxidant (Irganox 1010 manufactured by BASF Japan Ltd.) 6 parts by mass

Tetrahydrofuran 1,600 parts by mass

Toluene 400 parts by mass

Silicone oil (KF-54 manufactured by Shin-Etsu Chemical Co., Ltd.) 1 part by mass

These materials were mixed and dissolved to forma charge transport layer-forming coating liquid. The charge transport layer-forming coating liquid prepared was applied onto the charge generating layer by dip coating, so that a charge transport layer with a dry thickness of 20 μm was formed.

(Formation of Surface Protective Layer)

SnO₂ fine particles 1,250 parts by mass

Illustrative compound Mc-1 (SR350 manufactured by Sartomer Company Inc.) 900 parts by mass

Polymerization initiator (Irganox 819 manufactured by BASF Japan Ltd.) 70 parts by mass

Charge transport material T20-1 130 parts by mass

Antioxidant (Sumilizer GS manufactured by Sumitomo Chemical Co., Ltd.) 70 parts by mass

2-butanol 2,000 parts by mass

THF 250 parts by mass

Silicone oil (KF-96 manufactured by Shin-Etsu Chemical Co., Ltd.) 1 part by mass

These materials were sufficiently dissolved or dispersed by mixing and stirring to form a surface protective layer-forming coating liquid. The surface protective layer-forming coating liquid prepared was applied onto the charge transport layer using a circular slide hopper coater. After the application, the coating was irradiated with ultraviolet rays for 1 minute using a xenon lamp, so that a surface protective layer with a dry thickness of 2.0 μm was formed.

In this way, electrophotographic photoreceptor 1 was obtained.

<<Preparation of Electrophotographic Photoreceptors 2 to 25>>

Electrophotographic photoreceptors 2 to 25 were prepared as in the preparation of electrophotographic photoreceptor 1, except that charge transport material T20-1 as a material for the surface protective layer was replaced with each of charge transport materials T20-2 to T20-8, T50-1 to T50-8, T105-1, T1-1, T1-2, T11-1, T11-2, T12-1, T12-2, T61-1, and T61-2.

<<Evaluation of Electrophotographic Photoreceptors 1 to 25>>

Electrophotographic photoreceptors 1 to 25 prepared as described above were each evaluated as described below. Table 1 shows the evaluation results.

### (1) CRACK RESISTANCE

Immediately after the formation of the surface protective layer, the surface of each electrophotographic photoreceptor was observed with a microscope, and the presence or absence of cracks on the surface was visually determined and evaluated according to the following criteria.

∘: Cracks are absent.

x: Cracks are present.

### (2) TRANSFER MEMORY

In an environment at 23° C. and 50% RH, an endurance test was performed in which letter images with an image ratio of 6% were printed in the transverse direction simultaneously on both sides of each of 300,000 A4-size sheets. After the endurance test, an image with a mixture of solid black and solid white was printed simultaneously on 10 sheets, which was followed by the printing of a uniform halftone image. It was then visually observed whether or not the history of the solid black and the solid white appeared in the halftone image. The results of the observation were evaluated according to the following criteria.

⊙: No history appears (good).

∘: The history slightly appears (with no practical problem).

x: The history appears (with a practical problem).

### (3) POTENTIAL STABILITY

The above endurance test was performed with the initial charge potential controlled to 600±50 V. The change (ΔV) in the exposure unit potential between the initial stage and the stage after printing on 50,000 sheets was determined and evaluated according to the following criteria.

⊙: ΔV is less than 50 V (good).

∘: ΔV is 50 to 100 V (with no practical problem).

x: ΔV is more than 100 V (with a practical problem).

TABLE 1

| | Composition of surface protective layer | | | | | | | | |
|---|---|---|---|---|---|---|---|---|---|
| | Charge transport material | | | | | | | | |
| | | Cis-cis | Cis-trans | Trans-trans | Content (mass %) of | Evaluation results | | | |
| Electrophotographic | | form mass | form mass | form mass | most predominant | Crack | Transfer | Potential | |
| photoreceptor No. | No. | ratio | ratio | ratio | stereoisomer | resistance | memory | stability | Note |
| 1 | T20-1 | 1.0 | 2.1 | 1.0 | 51 | ◯ | ⊙ | ⊙ | Invention |
| 2 | T20-2 | 1.0 | 1.1 | 1.1 | 34 | ◯ | ◯ | ⊙ | Invention |
| 3 | T20-3 | 1.7 | 1.1 | 1.0 | 45 | ◯ | ⊙ | ⊙ | Invention |
| 4 | T20-4 | 1.5 | 3.0 | 1.0 | 55 | ◯ | ⊙ | ⊙ | Invention |
| 5 | T20-5 | 1.0 | 1.0 | 2.8 | 58 | ◯ | ◯ | ⊙ | Invention |
| 6 | T20-6 | 1.0 | 1.0 | 3.0 | 60 | ◯ | ◯ | ⊙ | Invention |
| 7 | T20-7 | 1.0 | 1.0 | 19.0 | 90 | ◯ | ◯ | ◯ | Invention |
| 8 | T20-8 | 0.0 | 0.0 | 1.0 | 100 | X | ◯ | X | Comparative |
| | | | | | | | | | Example |
| 9 | T50-1 | 1.1 | 2.2 | 1.0 | 51 | ◯ | ⊙ | ⊙ | Invention |
| 10 | T50-2 | 1.0 | 1.1 | 1.1 | 34 | ◯ | ◯ | ⊙ | Invention |
| 11 | T50-3 | 1.0 | 1.1 | 1.7 | 45 | ◯ | ⊙ | ⊙ | Invention |
| 12 | T50-4 | 1.5 | 3.0 | 1.0 | 55 | ◯ | ⊙ | ⊙ | Invention |
| 13 | T50-5 | 1.0 | 1.0 | 2.8 | 58 | ◯ | ◯ | ⊙ | Invention |
| 14 | T50-6 | 1.0 | 1.0 | 3.0 | 60 | ◯ | ◯ | ⊙ | Invention |
| 15 | T50-7 | 1.0 | 1.0 | 19.0 | 90 | ◯ | ◯ | ◯ | Invention |
| 16 | T50-8 | 0.0 | 0.0 | 1.0 | 100 | X | ⊙ | X | Comparative |
| | | | | | | | | | Example |
| 17 | T105-1 | 1.0(*1) | 0.0 | 1.1(*2) | 52 | ◯ | ◯ | ◯ | Invention |
| 18 | T1-1 | 1.0 | 2.1 | 1.0 | 51 | ◯ | ⊙ | ⊙ | Invention |
| 19 | T1-2 | 1.0 | 1.1 | 1.1 | 34 | ◯ | ◯ | ⊙ | Invention |
| 20 | T11-1 | 1.0 | 2.1 | 1.0 | 51 | ◯ | ⊙ | ⊙ | Invention |
| 21 | T11-2 | 1.0 | 1.1 | 1.1 | 34 | ◯ | ◯ | ⊙ | Invention |
| 22 | T12-1 | 1.0 | 2.1 | 1.0 | 51 | ◯ | ⊙ | ⊙ | Invention |
| 23 | T12-2 | 1.0 | 1.1 | 1.1 | 34 | ◯ | ◯ | ⊙ | Invention |
| 24 | T61-1 | 1.0 | 2.1 | 1.0 | 51 | ◯ | ⊙ | ⊙ | Invention |
| 25 | T61-2 | 1.0 | 1.1 | 1.1 | 34 | ◯ | ◯ | ⊙ | Invention |

(*1)cis form
(*2)trans form

### (4) CONCLUSION

It is apparent from the results in Table 1 that electrophotographic photoreceptors 1 to 7, 9 to 15, and 17 to 25 according to the present invention in which the charge transport material includes a mixture of stereoisomers have higher crack resistance than that of electrophotographic photoreceptors 8 and 16 as comparative examples. Therefore, the present invention makes it possible to provide electrophotographic photoreceptors with high crack resistance.

It is also apparent that electrophotographic photoreceptors 1 to 6, 9 to 14, and 17 to 25 in which the content of the most predominant stereoisomer is at most 60% by mass have higher potential stability than that of electrophotographic photoreceptors 7 and 15.

Although not shown in Table 1, if the content of the most predominant stereoisomer is 30% by mass or less, the charge transport material can have reduced solubility in the solvent for use in the formation of the surface protective layer, so that it can be difficult to form the surface protective layer. This would be because if the content of the most predominant stereoisomer is 30% by mass or less, the charge transport material will include many types of stereoisomers, in which some compounds would have a high molecular weight, which would reduce the solubility in the solvent for use in the formation of the surface protective layer.

Thus, setting the content of the most predominant stereoisomer to more than 30% by mass to 60% by mass makes it possible to increase the potential stability of the electrophotographic photoreceptor.

It is also apparent that electrophotographic photoreceptors 1, 3, 4, 9, 11, 12, 18, 20, 22, and 24 in which the content of the most predominant stereoisomer is 45 to 55% by mass are more effective in suppressing transfer memory than electrophotographic photoreceptors 2, 5, 6, 10, 13, 14, 19, 21, 23, and 25.

It is also apparent that electrophotographic photoreceptors 1 to 7, 9 to 15 and 18 to 25 including the compound with the structure of formula (1) as the charge transport material have higher potential stability than that of electrophotographic photoreceptor 17.

According to an embodiment of the present invention, the present invention makes it possible to provide an electrophotographic photoreceptor with high crack resistance and to provide an image forming apparatus having such an electrophotographic photoreceptor.

Although not clear, the advantageous effects of the present invention can be produced by the following mechanism.

When the surface protective layer of an electrophotographic photoreceptor contains a charge transport material, insufficient compatibility between the charge transport material and a curable monomer may cause the surface protective layer to crack. For example, even when the charge transport material is dissolved in a solvent and a monomer so that no aggregates form during the formation of a coating film, insufficient compatibility between the charge transport material and the crosslinking monomer can cause slight crystallization of the charge transport material in the process of forming a coating film, which can inhibit the crosslinking reaction and cause a local reduction in crosslink density. This can result in nonuniform crosslink density, so that stress can concentrate at low-crosslink-density part of the surface protective layer to cause cracking of the surface protective layer.

Such a phenomenon is significant particularly when the surface protective layer contains a photo-curable resin for improving durability. Therefore, a higher level of compatibility is required between the charge transport material and the photo-curable crosslinking monomer.

To improve crack resistance, it is important to prevent the inhibition of the crosslinking reaction of the crosslinking monomer. A measure for this is a method of reducing the crystallinity of the charge transport material. In this regard, if the compound used as the charge transport material only has a single stereoisomer, the charge transport material can have high crystallinity. According to the present invention, therefore, a mixture of two or more stereoisomers is used as a charge transport material, which makes it possible to suppress the crystallization of the charge transport material and thus to obtain a surface protective layer with good crack resistance and high strength. In addition, further improved performance can be achieved when the content of stereoisomers in the charge transport material is controlled to fall within a specific range.

Although the present invention has been described and illustrated in detail, it is clearly understood that the same is by way of illustrated and example only and is not to be taken byway of limitation, the scope of the present invention being interpreted by terms of the appended claims.

What is claimed is:

1. An electrophotographic photoreceptor comprising:
a conductive support; a photosensitive layer comprising at least an organic material; and
a surface protective layer, wherein
the photosensitive layer and the surface protective layer are provided on the conductive support, and the surface protective layer comprises a structural unit derived from a photo-curable crosslinking monomer and a charge transport material comprising a mixture of a plurality of stereoisomers.

2. The electrophotographic photoreceptor according to claim 1, wherein a most predominant stereoisomer makes up more than 30% by mass to 60% by mass of all stereoisomers in the charge transport material.

3. The electrophotographic photoreceptor according to claim 1, wherein the charge transport material is a compound having a structure represented by formula (1): 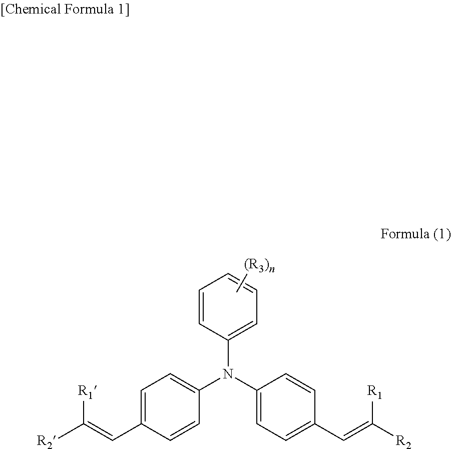
wherein R₁, R₂, R₁′, and R₂′ each independently represent a hydrogen atom or a substituted or unsubstituted aromatic group, R₁≠R₂ and R₁′≠R₂′, R₃ represents a hydrogen atom or an alkyl or alkoxy group of 1 to 4 carbon atoms, and n represents an integer of 1 to 5.

4. The electrophotographic photoreceptor according to claim 1, wherein a most predominant stereoisomer makes up 45% by mass to 55% by mass of all stereoisomers in the charge transport material.

5. The electrophotographic photoreceptor according to claim 1, wherein the crosslinking monomer has an acryloyl group or a methacryloyl group as a functional group.

6. The electrophotographic photoreceptor according to claim 1, wherein the charge transport material is a compound having a triphenylamine structure.

7. The electrophotographic photoreceptor according to claim 5, wherein the crosslinking monomer has a methacryloyl group.

8. The electrophotographic photoreceptor according to claim 1, wherein the crosslinking monomer has a compound with three or more functional groups, and the content of the compound is 50% by mass or more.

9. An image forming apparatus comprising the electrophotographic photoreceptor according to claim 1, a charging unit, an exposure unit, a developing unit, and a transfer unit, wherein the charging unit, the exposure unit, the developing unit, and the transfer unit are provided around the electrophotographic photoreceptor.
